(19) United States
(12) Patent Application Publication
(10) Pub. No.: US 2002/0147972 A1
(43) Pub. Date: Oct. 10, 2002

(54) System and method for configuring an application environment on a computer platform

(76) Inventors: Hector M. Olmeda, Denville, NJ (US); Carlo Iaboni, Jersey City, NJ (US)

Correspondence Address: Neil G. Cohen, Esq., OptiMark, Inc., 10 Exchange Place, Jersey City, NJ, 07302, US

(21) Appl. No.: 09/773,258

(22) Filed: Jan. 31, 2001

(51) Int. Cl. G06F 9/445

(52) U.S. Cl. 717/174

(57) ABSTRACT

A method is disclosed for configuring an environment on a host computer platform to facilitate installation of an application. The method includes the steps of providing environment-dependant command lines containing a plurality of tokens, providing environment-dependant contextual data describing an environment, generating the environment by replacing the tokens in the environment-dependant command lines with environment-dependant contextual data describing the environment, and transferring the environment to the host computer platform for configuration.

### COPYRIGHT NOTICE

A portion of the disclosure of this patent document contains material that is subject to copyright protection. The copyright owner has no objection to the facsimile reproduction by anyone of this patent document or patent disclosure as it appears in the Patent and Trademark Office, patent file or records, but otherwise reserves all copyright rights whatsoever.

### FIELD OF INVENTION

The present invention is directed to an automated system and method for configuring an environment on a computer platform to facilitate the installation of an application.

### BACKGROUND OF THE INVENTION

Data integrity is a key requirement for business-critical computing. Stock exchanges, banks, telecommunications companies, and transaction processing applications of most businesses cannot afford to risk the integrity of their data. Rapidly advancing computer systems are so complex that it is extremely difficult to design for or test for all potential timing problems, unexpected interactions, and non-repeatable transient states that occur in the real world. A truly safe computing environment can only be achieved if data integrity is a primary design objective.

Fault tolerant computer systems that ensure data integrity are well known in the art and are commonly utilized for business-critical computing. In particular, the Compaq NonStop computing system (formerly Tandem Computer System) has been designed to assure data integrity by employing two lockstepped microprocessor chips, which concurrently run the same instruction stream. The output from the two microprocessors is compared, and if it should ever differ, the processor output is frozen within a few nanoseconds so that the corrupted data cannot propagate. This prevents bit flips caused by such things as high energy, power fluctuations, manufacturing imperfections, and timing errors from being used in calculations and corrupting a database. Compaq NonStop servers are also scalable in that each host computer is made up of one or more cabinets, with each cabinet having a pair of mirrored CPUs and pairs of disk drives, and having the ability to grow to eight cabinets containing 16 CPUs and over a hundred disk drives.

Multiple copies of a particular application can run on a Compaq NonStop server, and each application or group of programs may be spread out over the server in a different manner so as to optimize the throughput of the system. This enables each application to be concurrently used for a different purpose. For example, one application may be employed for stress testing, while three other applications are used for training purposes. This also enables different versions or releases of a particular application to run concurrently over the system.

The Compaq NonStop server includes a Transaction Monitor called Pathway that manages the various services that an application provides. Pathway is parameter driven so that most changes can be made to an application configuration without re-programming or restarting the application. This is what makes Pathway so unique as compared to other transaction monitors known in the art, such as Tuxedo for Unix and NT. It also means that managing the hundreds of parameters that make up a Pathway application's configuration is extremely time consuming and labor intensive. Typically, a configuration manager creates a file called PATHCONF with a text editor on the associated host computer to create or update configurable preferences such as path statements. This file is equivalent to the AUTOEXEC. BAT of an IBM-compatible personal computer. Other configurable information may involve initialization information as in an initialization (.ini) file of a personal computer.

The configuration management system of the subject invention is designed to create configuration files for a Pathway application in an automated fashion. This is primarily accomplished using code generation, so that it is relatively easy to clone an existing application environment and install a new Pathway application thereon in a relatively short period of time, as compared to prior art configuration methods. This greatly enhances the ability to manage updated release installation.

Automated application code generators are known in the art. They contain preprogrammed modules that generate entire applications, greatly speeding development. A user can specify what needs to be done, and the application code generator will create the appropriate code for input, validation, update, processing and reporting. U.S. Pat. No. 6,515,605 discloses a method for configuring software applications that utilizes code generation. The method provides a configuration processing library that implements a configuration file processor. An application is compiled with the configuration file processing library, which defines a set of C++ classes required by the application to generate generic configuration file processing code for reading and manipulating data in a generic configuration file. When executed, the application instantiates a configuration file processor application programming interface through which a configuration file is read or manipulated.

While the use of automated code generation to configure software applications is known, these techniques have not been employed to automate the configuration of an application environment, such as, for example, a Pathway application environment. It would be beneficial therefore, to provide a system and method for configuring an environment on a computer platform, such as a Compaq NonStop server platform, to facilitate installation of an application, such as a Pathway application, in an efficient manner. Using such a system and method, a configuration script would be produced by a code generator. The script would then be downloaded to the platform, where it would be executed to build the environment. After the environment is built, the application can be installed thereon.

### SUMMARY OF THE INVENTION

In accordance with a preferred embodiment of the subject invention, there is disclosed a method for configuring an environment on a computer platform to facilitate installation of an application. The method includes the steps of providing environment-dependant command lines containing a plurality of tokens, providing environment-dependant contextual data describing the environment, and generating the environment by replacing the tokens in the environment-dependant command lines with environment-dependant contextual data describing the environment.

In a generic, multi-platform context, the method further includes the steps of providing application-dependant rules for parsing and composing environment-dependant command lines, the application-dependant rules containing a plurality of tokens, providing application-dependant contextual data describing an application configuration, and generating the application configuration by replacing the tokens in the application-dependant rules with application-dependant contextual data.

The method further includes the steps of providing platform-dependant rules for parsing and composing application-dependant command lines, the platform-dependant rules containing a plurality of tokens, providing platform-dependant contextual data describing a platform convention, and generating the platform convention by replacing the tokens in the platform-dependant rules with platform-dependant contextual data.

In addition, the method includes the steps of transferring the platform convention to the computer platform, transferring the application configuration to the computer platform for installation based upon the platform convention, and transferring the environment to the computer platform for configuration based upon the application configuration.

Preferably, the step of providing environment-dependant contextual data includes providing user specified contextual data describing the environment, the step of providing application-dependant contextual data includes providing user-specified contextual data describing the application configuration, and the step of providing platform-dependant contextual data includes providing user-specified data describing the platform convention.

Alternatively, the step of providing environment-dependant contextual data includes providing default data describing the environment, the step of providing application-dependant contextual data includes providing default data describing the application configuration, and the step of providing platform-dependant contextual data includes providing default data describing the platform convention.

A method is also disclosed for configuring an application environment on a host computer to facilitate installation of an application thereon. The method comprises the steps of providing a file containing a plurality of tokenized command lines for configuring an application environment, providing contextual data describing the application environment, generating a configuration script file by merging the contextual data with the tokenized command lines, transferring the configuration script file to the host computer, and subsequently configuring the application environment on the host computer based upon the configuration script file. The method further includes the step of populating the application environment.

The subject invention is also directed to a system for configuring an environment on a computer platform to facilitate installation of an application. The system includes environment-dependant command lines containing a plurality of tokens, environment-dependant contextual data describing an environment, and an environment code generator for generating the environment by replacing the tokens in the environment-dependant command lines with environment-dependant contextual data.

In a generic, multi-platform context, the system further includes application-dependant rules for parsing and composing environment-dependant command lines, the application-dependant rules containing a plurality of tokens, application-dependant contextual data describing an application configuration, and an application code generator for generating the application configuration by replacing the tokens in the application-dependant rules with application-dependant contextual data.

The system further includes platform-dependant rules for parsing and composing application-dependant command lines, the platform-dependant rules containing a plurality of tokens, platform-dependant contextual data describing a platform convention, and a platform code generator for generating the platform convention by replacing the tokens in the platform-dependant rules with platform-dependant contextual data.

In accordance with a preferred embodiment of the subject invention, there is disclosed a software configuration management system for configuring a Pathway application environment on a Compaq NonStop Server to facilitate installation of a Pathway application thereon. The system includes a file containing a plurality of tokenized command lines for configuring a Pathway application environment, and contextual data describing the Pathway application environment, including, among other things, data relating to process instances for server classes, disc volume locations for files and backup assignments for CPUs. The system also includes means for generating a configuration script file by merging the contextual data with the tokenized command lines, means for transferring the configuration script file to the host computer, and means for configuring the Pathway application environment on the host computer based upon the configuration script file.

Preferably, the means for transferring the configuration script file to the host computer includes file transfer protocols, and the means for configuring the application environment includes configuration routines written in a command language understood by the host computer. In addition, the system includes means for populating the Pathway application environment with application programs, means for testing environment configuration parameters based upon established rules, means for validating environment configuration files, means for installing environment configuration files in the environment using appropriate commands, and means for modifying any alternate keys of environment configuration files that have been copied. The system further includes means for running file conversion routines required to change the environment from a release currently installed to a release being installed, and means for creating the release identification file in a target location and in the environment using a name of the release being installed.

There is also disclosed herein a computer-readable medium, the content of which causes a computer system to configure an environment on a host computer to facilitate installation of an application thereon, by performing the steps of providing a script file containing a plurality of tokenized command lines for configuring an application environment, providing a data file containing contextual configuration data describing the application environment, and generating a configuration script file by merging the contextual configuration data from the data file with the tokenized command lines of the script file for subsequent transfer the host computer to configure the application.

These and other unique aspects of the system and method of the subject invention disclosed herein will become more readily apparent to those having ordinary skill in the art from the following detailed description of the invention taken in conjunction with the drawings described hereinbelow.

### BRIEF DESCRIPTION OF THE DRAWINGS

So that those having ordinary skill in the art to which the subject invention pertains will more readily understand how to employ the system and methodology of the subject invention, preferred embodiments thereof will be described in detail hereinbelow with reference to the drawings, wherein:

FIG. 1 illustrates the Startup worksheet of the workbook utilized in conjunction with the software configuration management system of the subject invention;

FIG. 2 illustrates the Data Location table and File Transfer Protocol table of the Initialization worksheet of the workbook utilized in conjunction with the software configuration management system of the subject invention;

FIG. 3 illustrates the Script File table and Program Location table of the Initialization worksheet of the workbook utilized in conjunction with the software configuration management system of the subject;

FIG. 4 illustrates the Number of CPU's table and Valid CPU Count table of the Initialization worksheet of the workbook utilized in conjunction with the software configuration management system of the subject;

FIG. 5 illustrates the CPU's worksheet of the workbook utilized in conjunction with the software configuration management system of the subject invention to determine the assignments for backup processes given the CPU used for the primary process;

FIG. 6 illustrates Template Server Class worksheet of the workbook utilized in conjunction with the software configuration management system of the subject invention;

FIG. 7 illustrates the Process table of the environment worksheet of the workbook utilized in conjunction with the software configuration management system of the subject invention which contains the server process instance to be run in each CPU;

FIG. 8 illustrates the Files table of the environment worksheet of the workbook utilized in conjunction with the software configuration management system of the subject invention which contains the file names that will be places on the disk volume specified in the column header;

FIGS. 8A through 8C illustrate the configuration data tables of alternate environment specific worksheet configured in accordance with a preferred embodiment of the subject invention;

FIGS. 9 through 11 illustrates the Common tables of the environment worksheet of the workbook utilized in conjunction with the software configuration management system of the subject invention which includes data tables containing subsystem;

FIG. 12 illustrates a Configuration Log File constructed in accordance with a preferred embodiment of the subject invention;

FIG. 12A illustrates a workbook screen containing the Configuration Command Bars utilized to build, view and transfer a configuration script in accordance with a preferred embodiment of the subject invention; and

FIG. 13 is a schematic representation of a generic multi-platform software configuration management system constructed in accordance with a preferred embodiment of the subject invention, which includes, among other things, a platform code generator, an application code generator, and an environment code generator.

### DETAILED DESCRIPTION OF THE DISCLOSURE

The subject disclosure is directed to a Software Configuration Management (SCM) system which consists of a set of tools, procedures and proprietary software for configuring and managing software applications on a host computer employed in such areas as stock exchanges, banks and telecommunications companies. More particularly, in accordance with a preferred embodiment of the subject invention, the SCM system is designed to rapidly bring up a new application environment to facilitate the installation of a Pathway application on a Compaq NonStop server, and to efficiently recreate an environment when a Pathway application is upgraded to a new version. The SCM system creates all the existing files the application requires, and can convert files from one format to another when required to upgrade the application.

The SCM system of the subject invention includes three primary components for configuring an iii environment on a host computer, such as, for example, a Compaq NonStop server, to facilitate installation of an application, such as, for example, a Pathway application. These include a script containing a plurality of tokenized command lines for configuring an application environment, a set of user-specified contextual data preferably contained within a spreadsheet or similar data support structure describing a specific application environment, and an environment code generator in the form of a program for building the configuration script files by merging the contextual data with the tokenized command lines. These components are contained on a computer readable storage medium, such as a CD-ROM, that is installed on a configuration workstation. In addition, the system may employ protocols for transferring the configuration script files to the host computer, a series of routines for installing and configuring the application environment on the host computer based upon the configuration script files, and a repository for populating the application environment after it has been installed and configured.

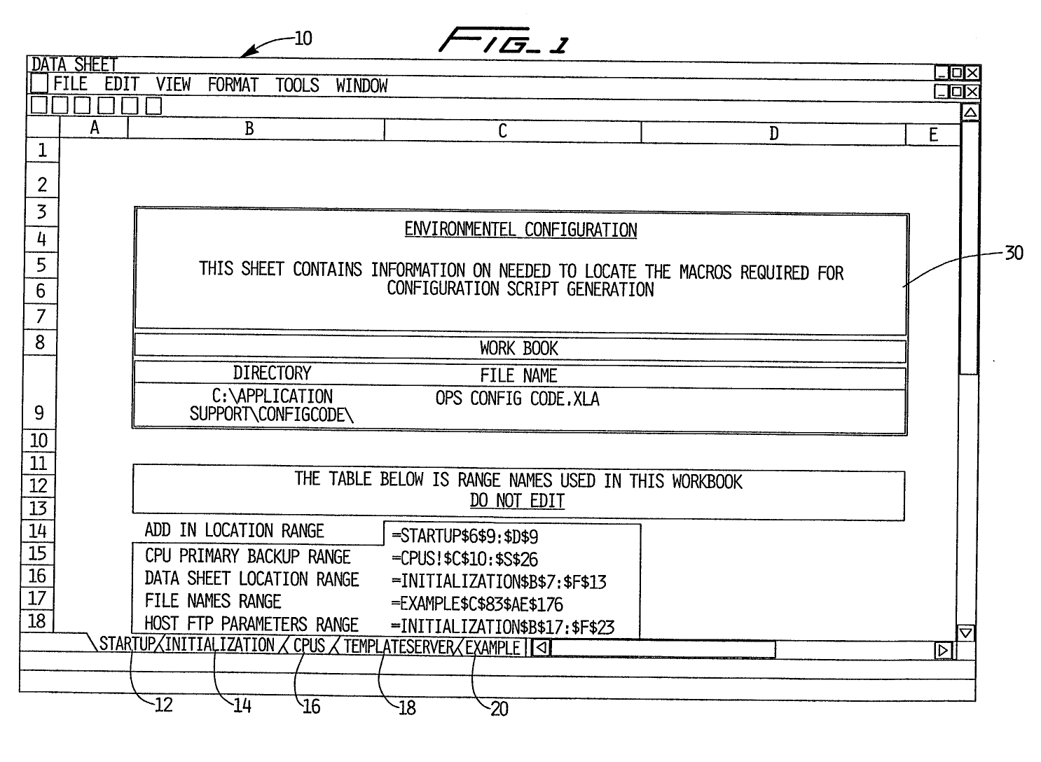

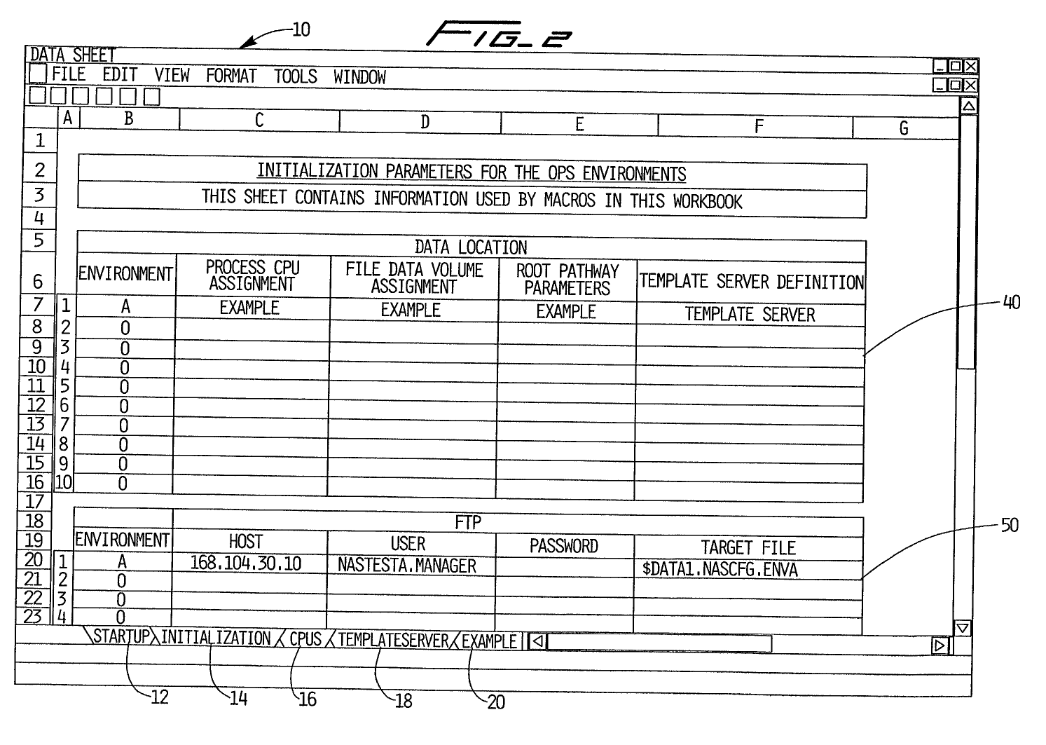

Referring now to the drawings wherein like reference numerals identify similar aspects of the system disclosed herein, there is illustrated in FIG. 1 a workbook constructed in accordance with a preferred embodiment of the subject invention and designated generally by reference numeral 10. Workbook 10 is a Microsoft Excel workbook that contains a plurality of data sheet elements or worksheets containing user-specified data and default data describing a specific application environment. As used herein, the terms data sheet and worksheet shall be used interchangeably as described in conjunction with a workbook. Each data sheet element has a corresponding tab located on a horizontal menu bar 12. These data sheet include the Startup data sheet 12, the Initialization data sheet 14, the CPU's data sheet 16 and the Template Server data sheet 18, as well as one or more environment configuration worksheets each corresponding to a specific environment, such as the Example worksheet 20. It is envisioned that a single workbook could contain configuration data for a plurality of different application environments. It is also envisioned that individual workbooks could be provided for each of a plurality of different application environments. In such instances, a given workstation could be employed to configure one environment or a plurality of different application environments.

Since workbook 10 is a Microsoft Excel workbook, the configuration worksheets are comprised of a plurality of cells each containing data. In accordance with the subject invention, certain cells have comments associated therewith to assist the user in understanding the function of various cells in different parts of the configuration worksheets. These can be turned on and off with a data input device. The cells of certain worksheets have validation protocols invoked. This prevents the inadvertent entry of invalid data. Drop down lists containing valid inputs are also used to assist in data entry. Those skilled in the art will readily appreciate that spreadsheet based programs other than Microsoft Excel, as well as other types of structural data input programs may be utilized in conjunction with the disclosed SCM system without departing from the spirit or scope of the subject invention.

The Startup data sheet 12 illustrated in FIG. 1 contains information needed to locate the macros required for configuration script generation, otherwise referred to as the code generator. More particularly, data sheet 12 has a table 30 that contains the location, path and file name of the Excel “Addin” file (.xla) utilized for each identified environment. As illustrated, the directory path is C:\ApplicationSupport\Configcode\ and the file name is OpsConfigcode. xla. Preferably, the data workbook 10 includes the code required to load the “Addin” file, which is automatically executed when the workbook is opened. Before the workbook is closed, the “Addin” file is removed. In accordance with a preferred embodiment of the subject invention, the configuration script generation program is written in Microsoft Visual Basic. However, those skilled in the art will readily appreciate that the code generator can be written in an equivalent computing language.

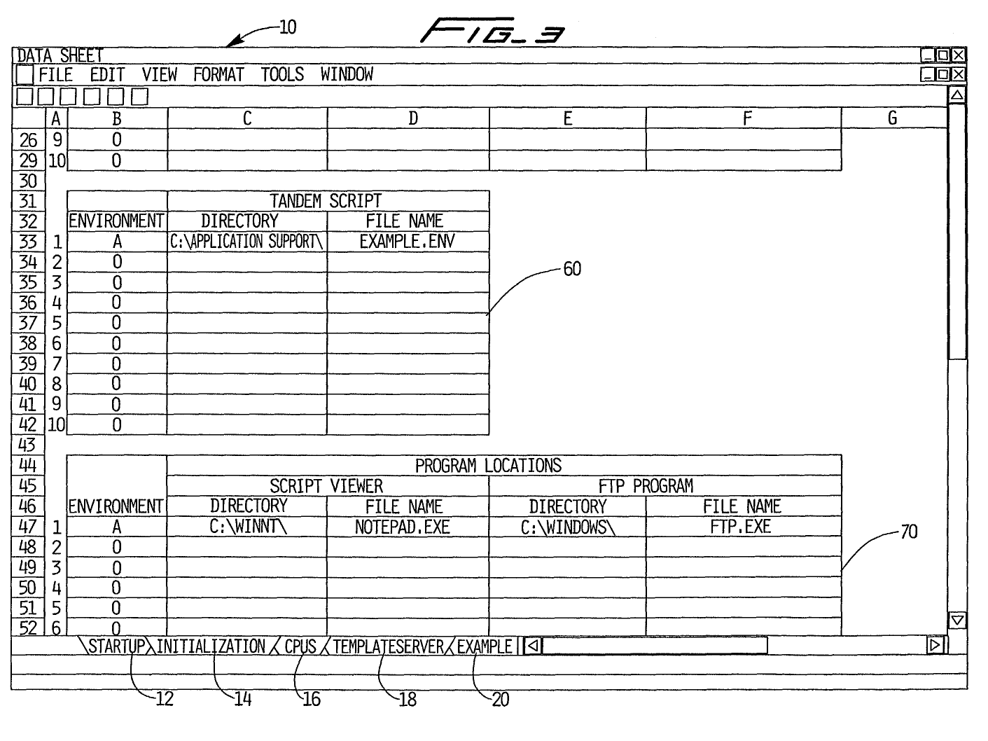

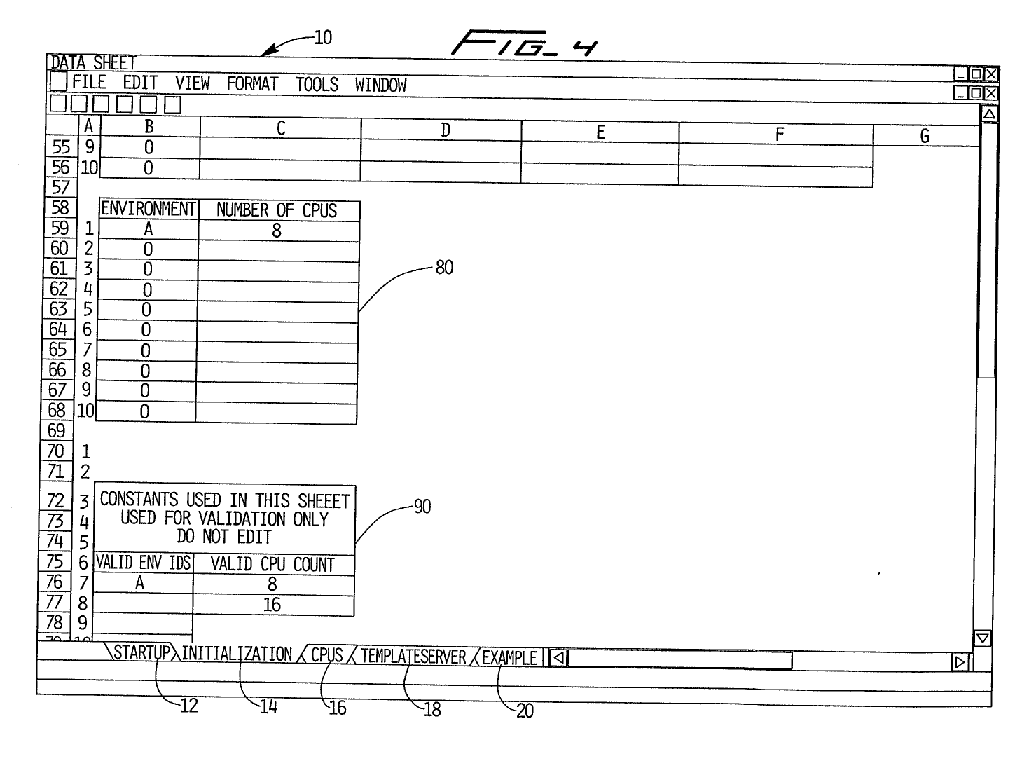

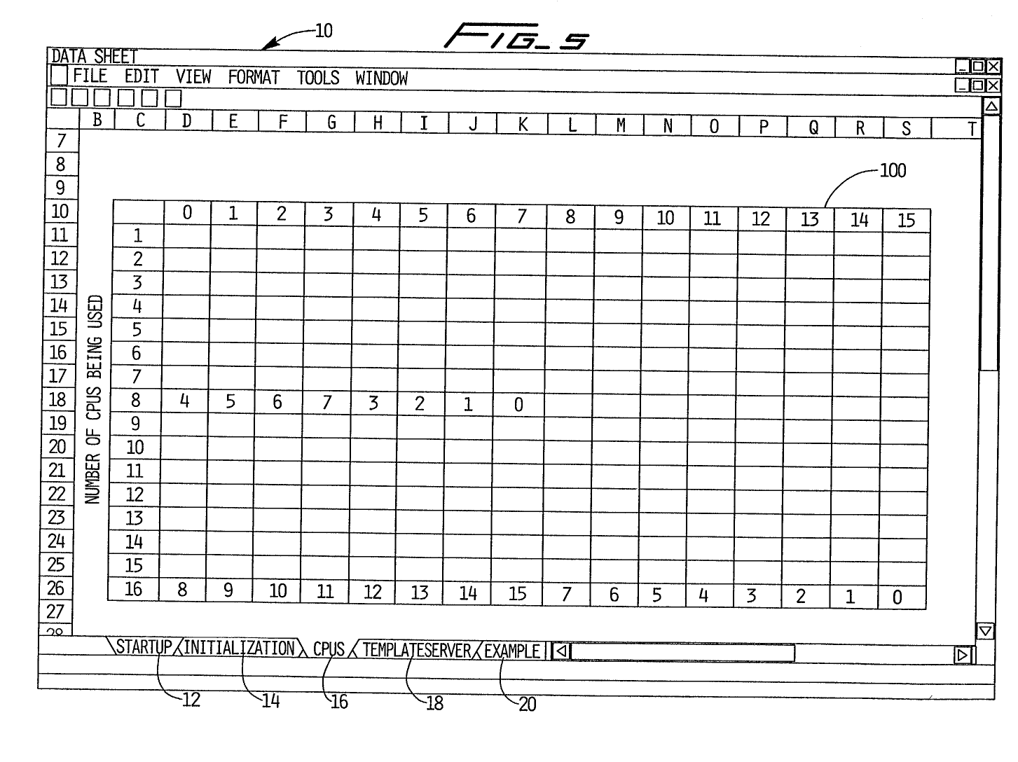

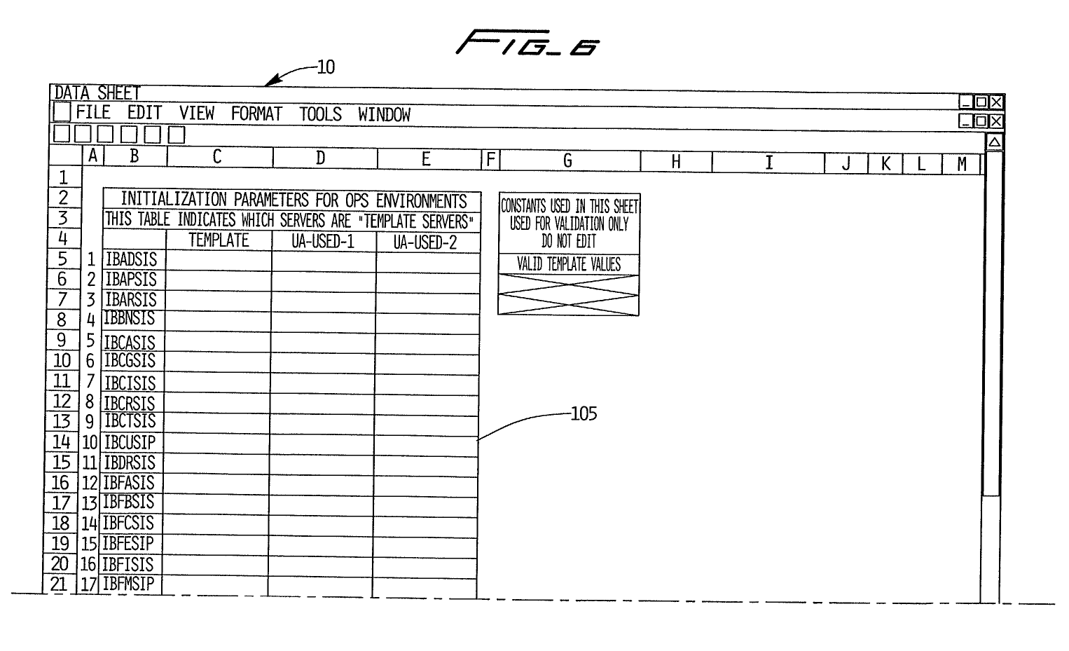

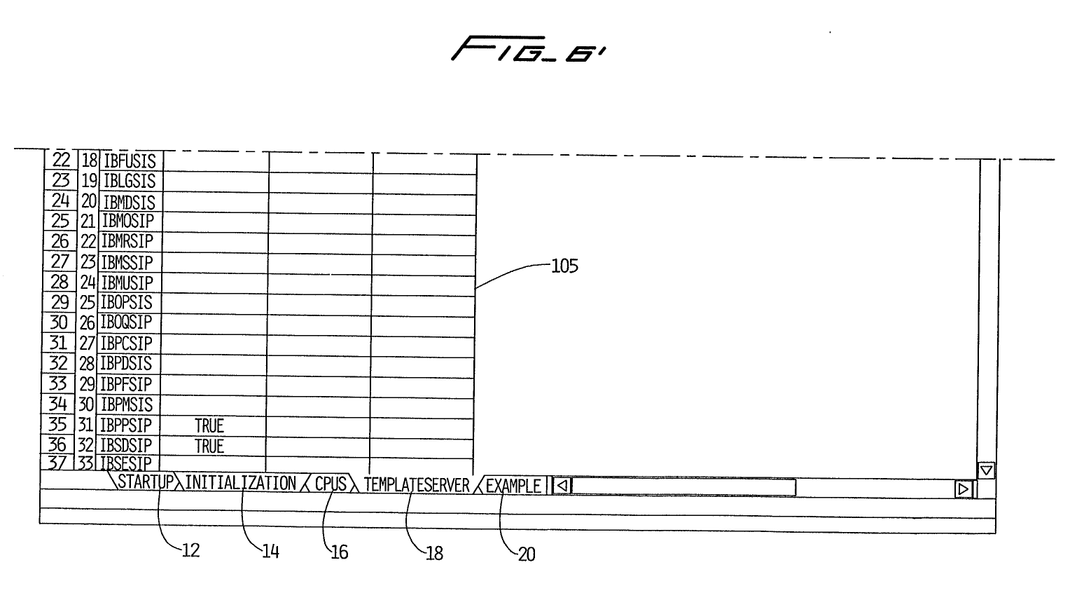

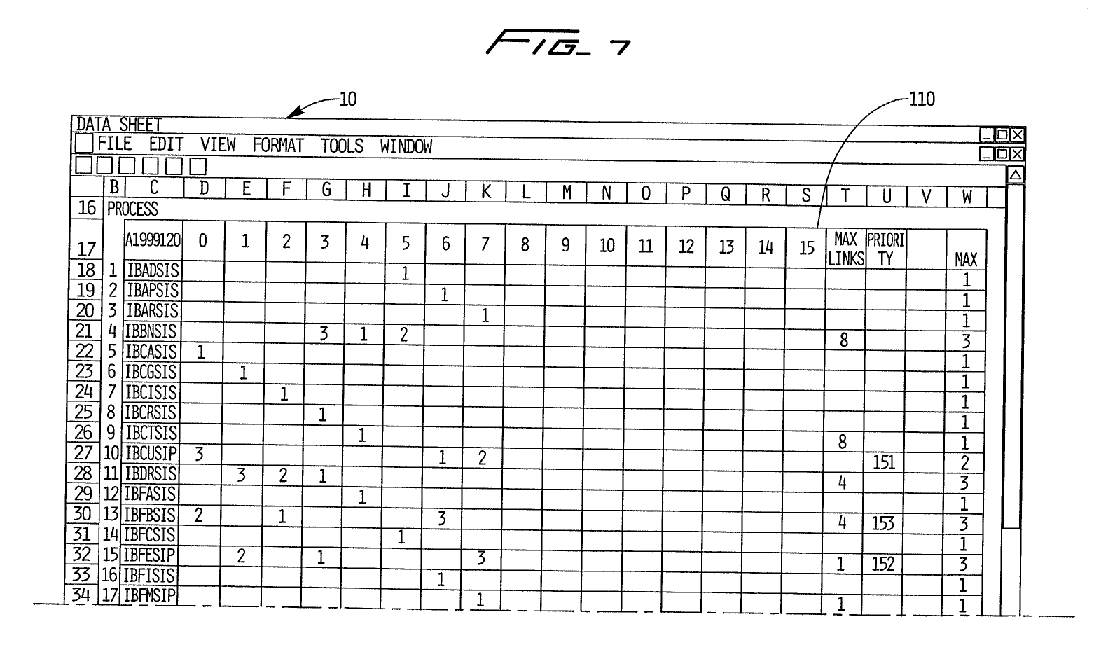

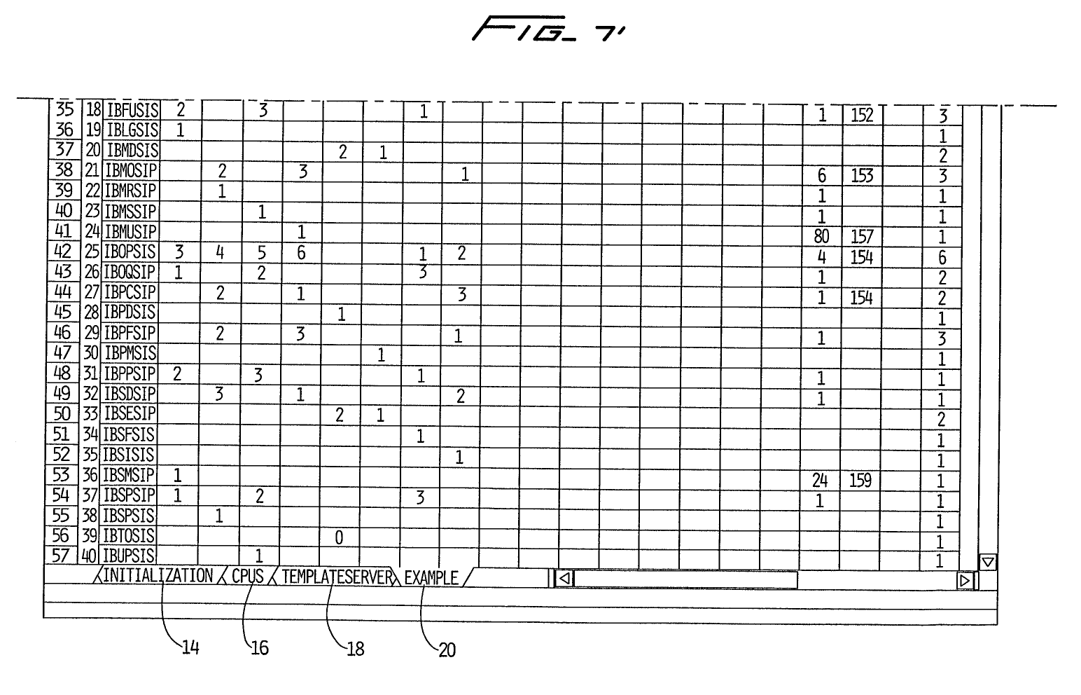

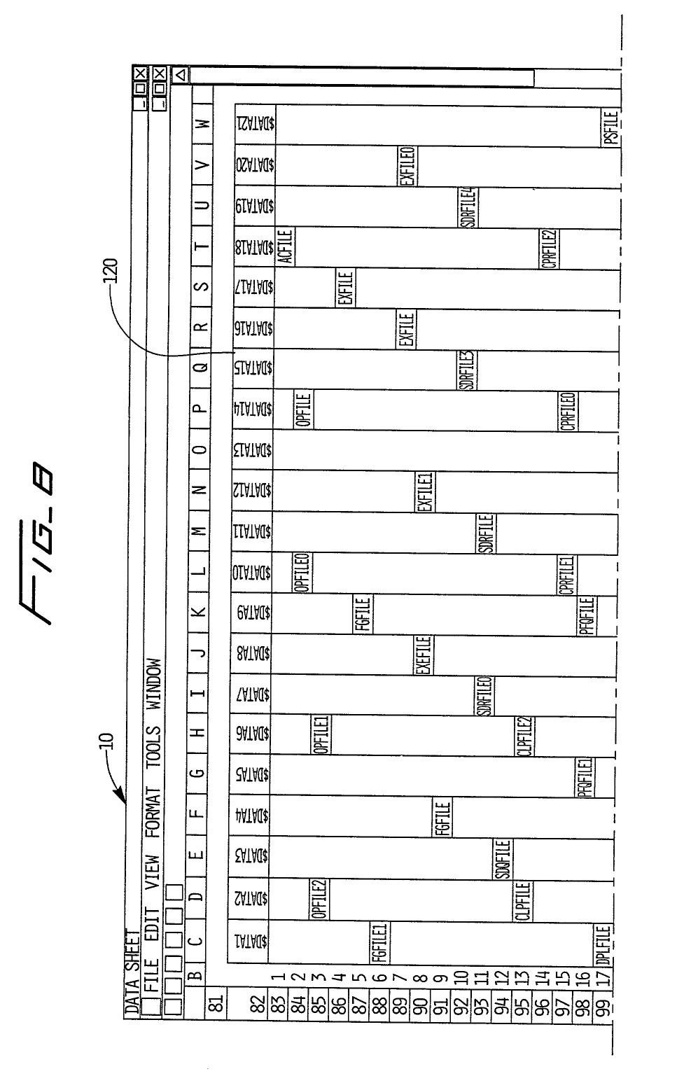

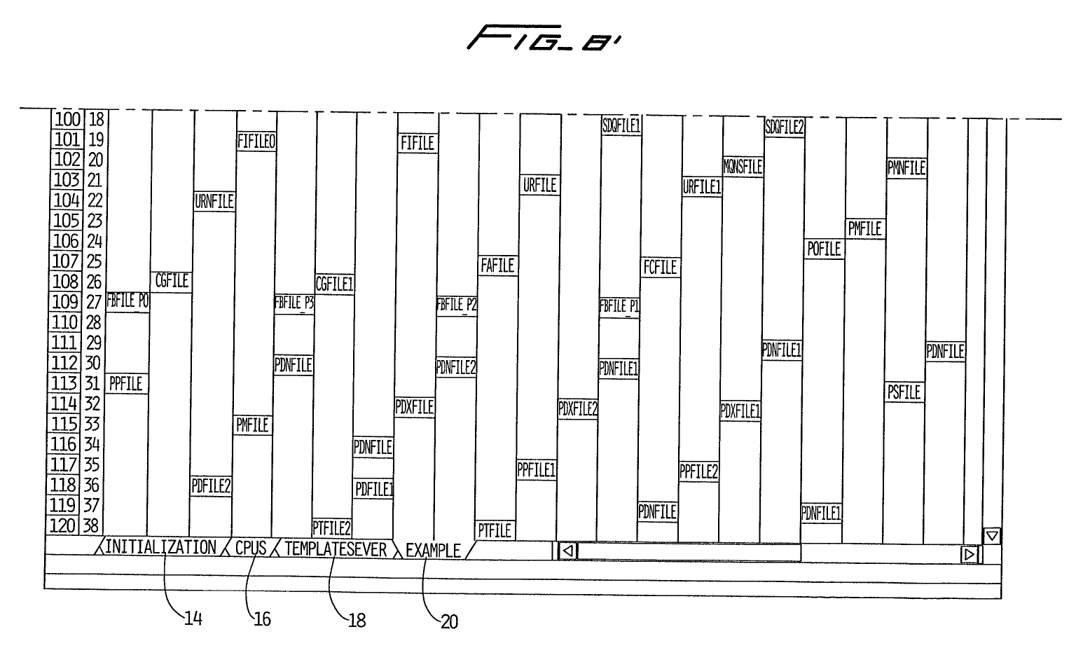

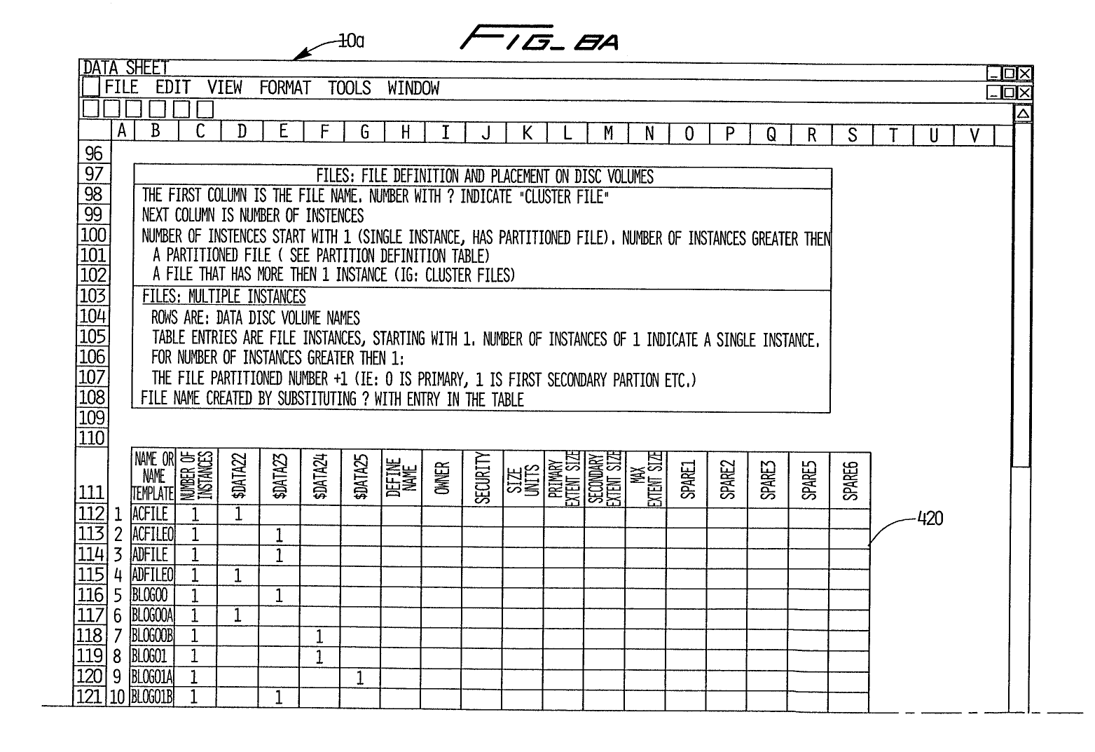

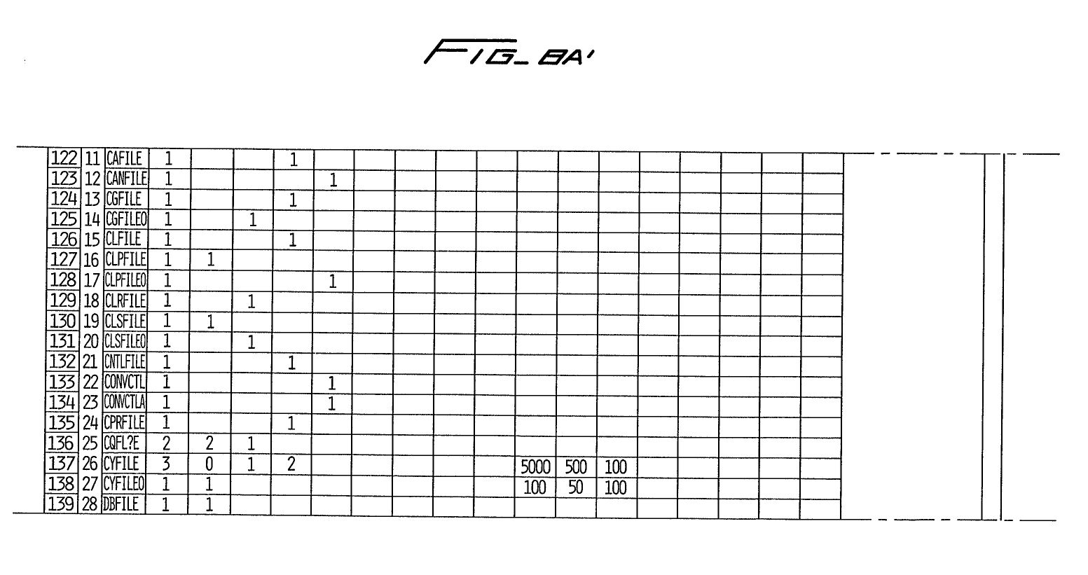

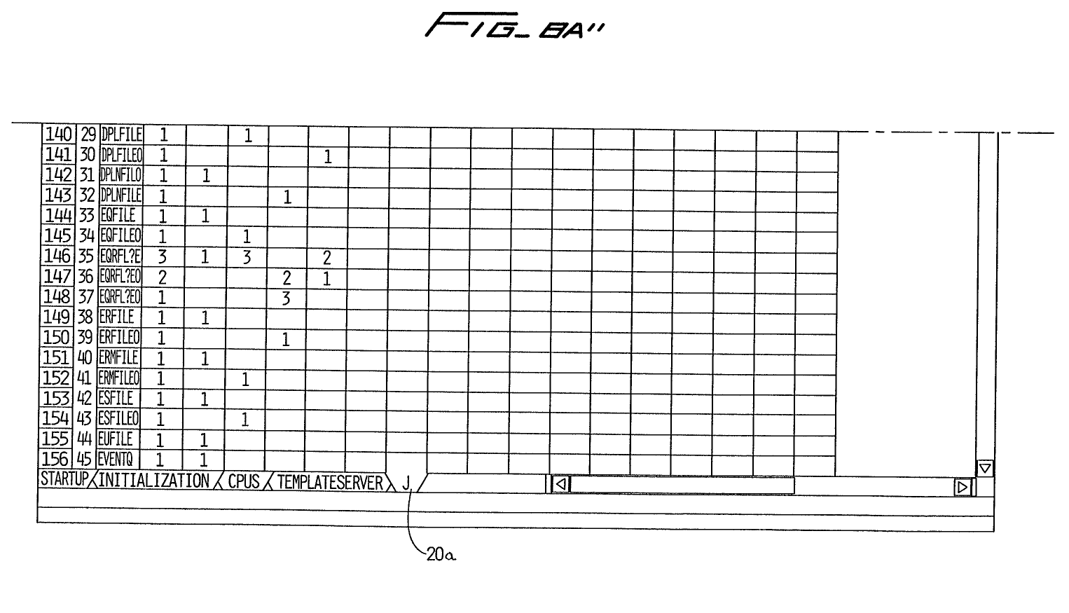

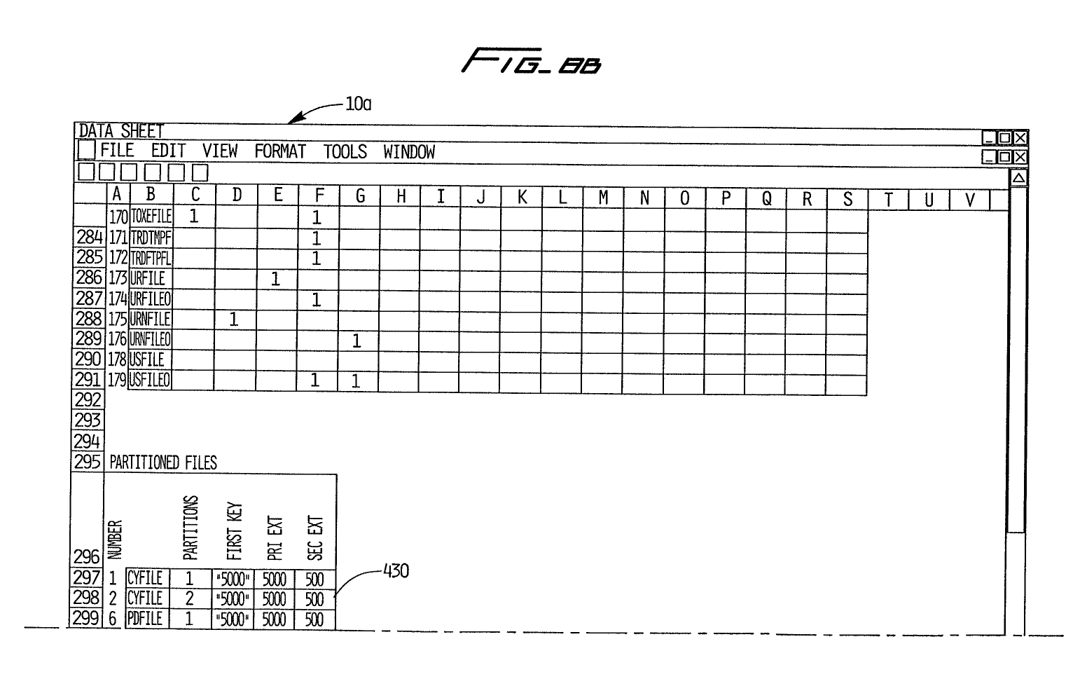

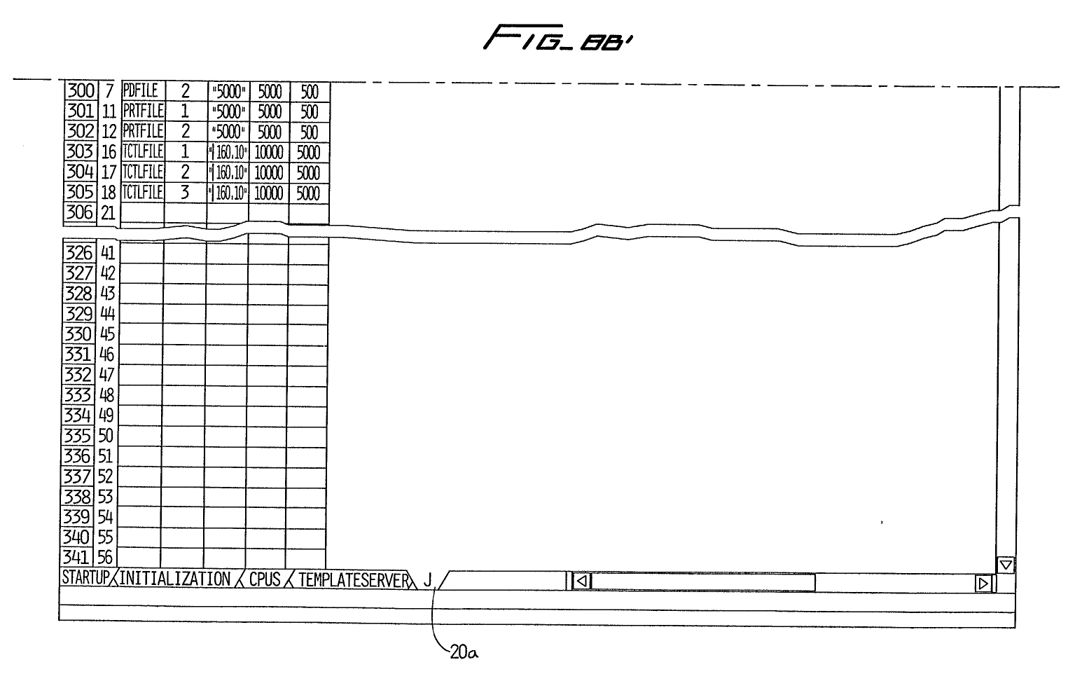

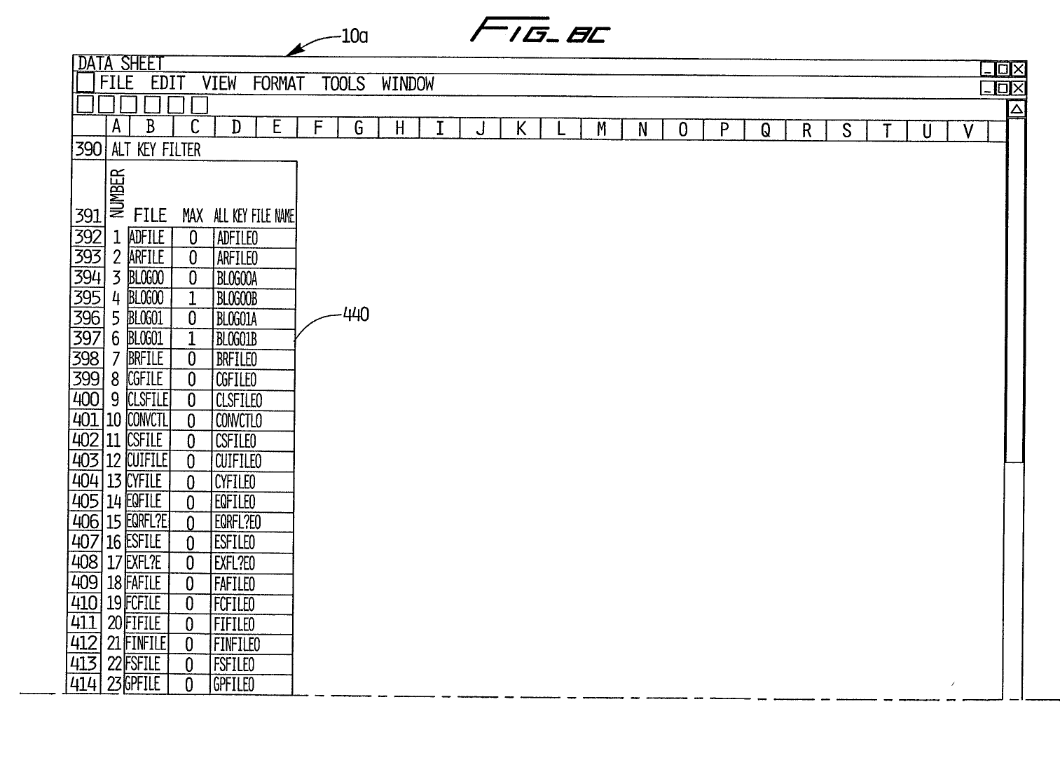

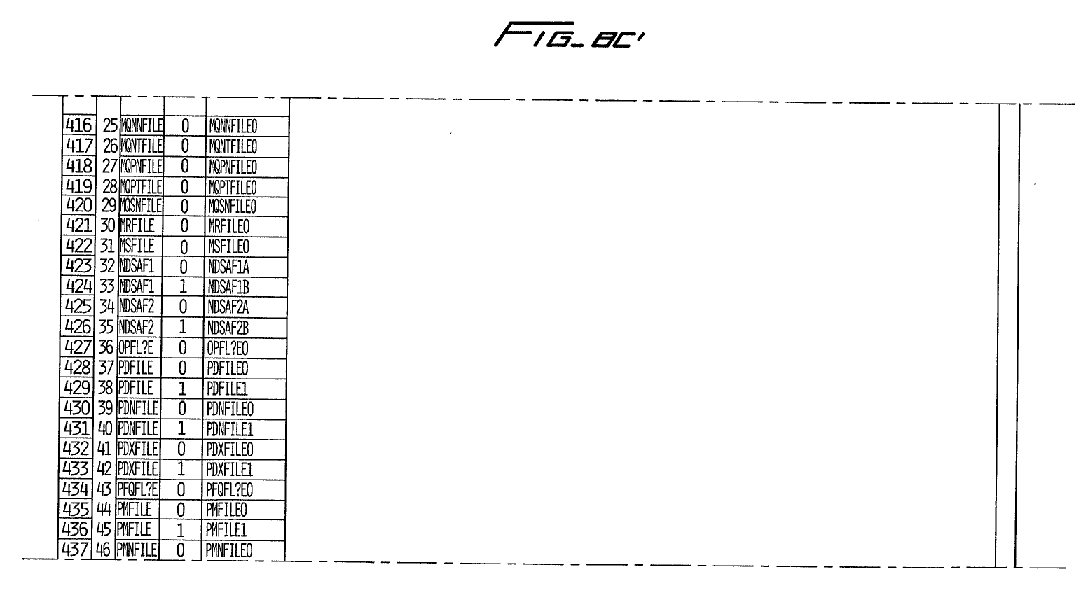

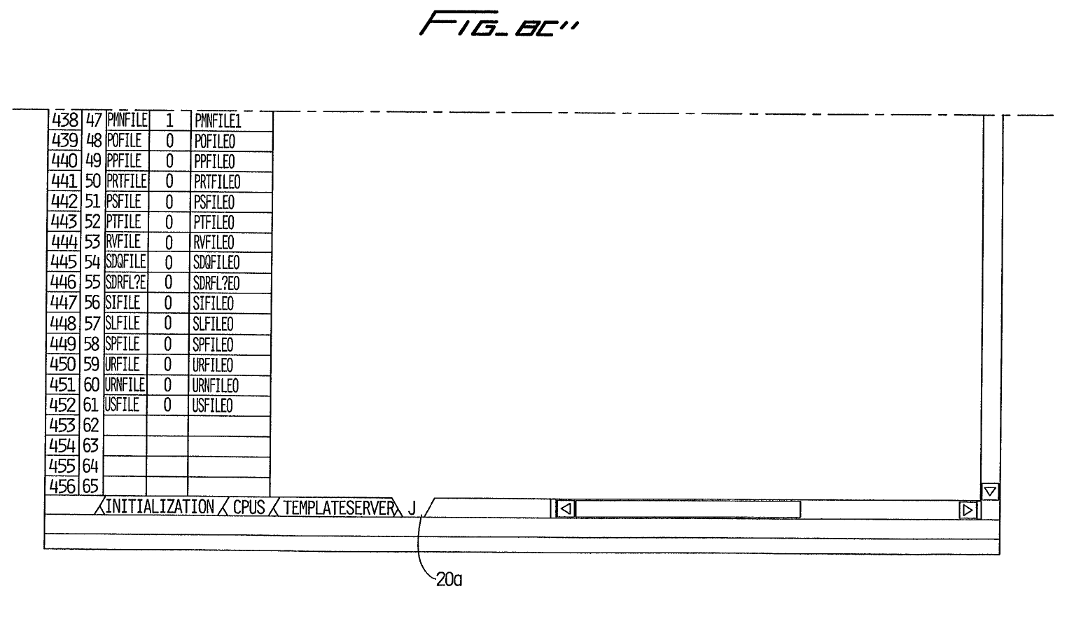

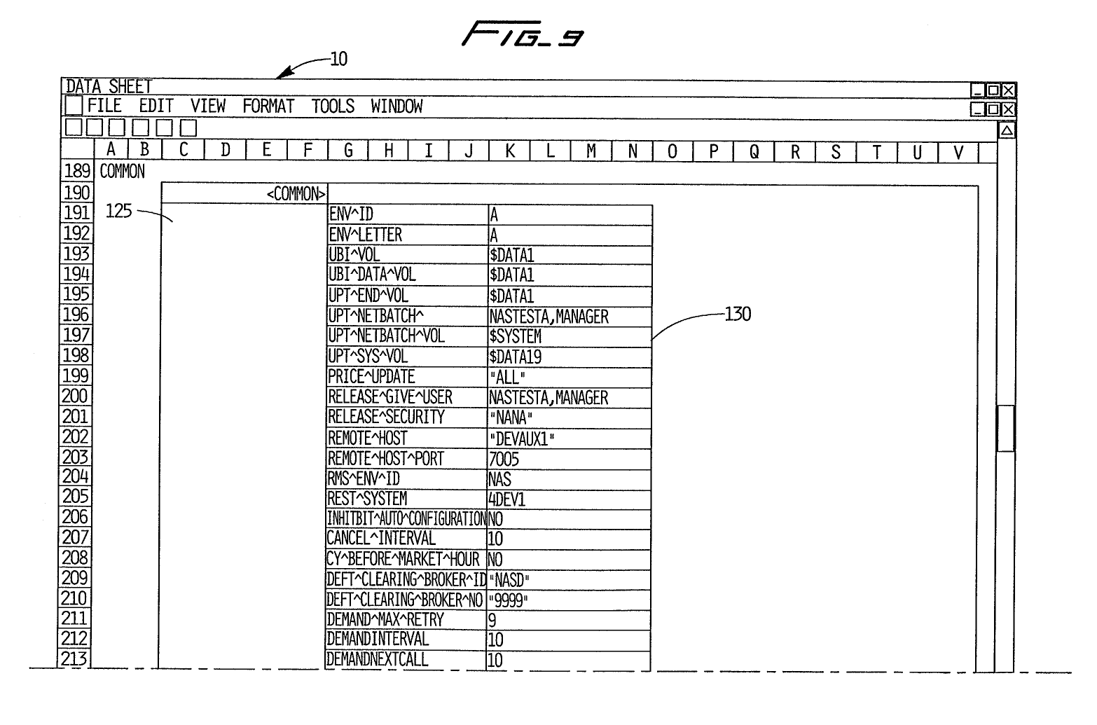

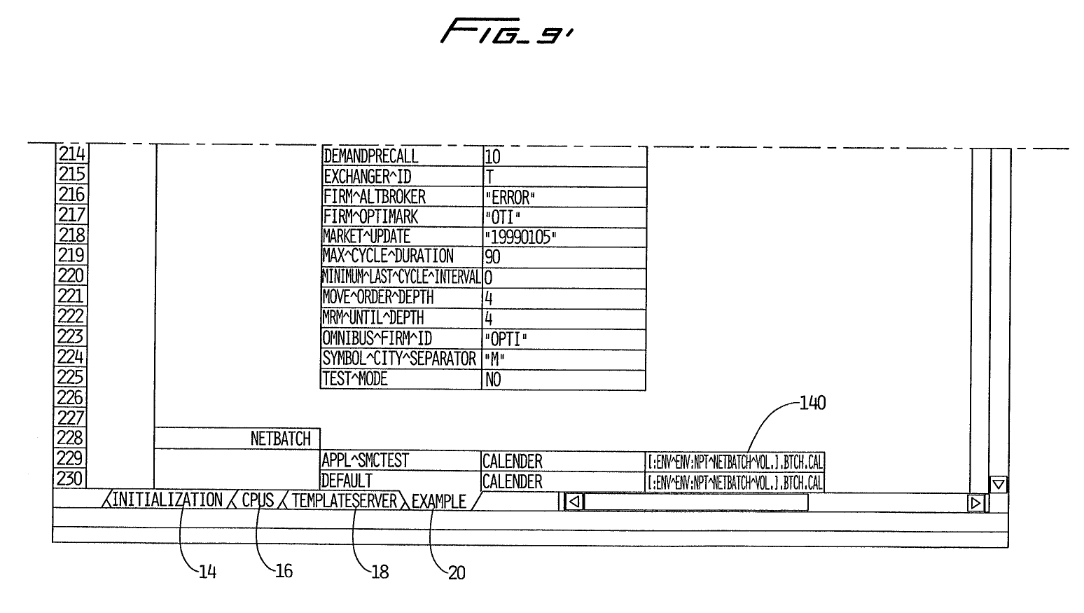

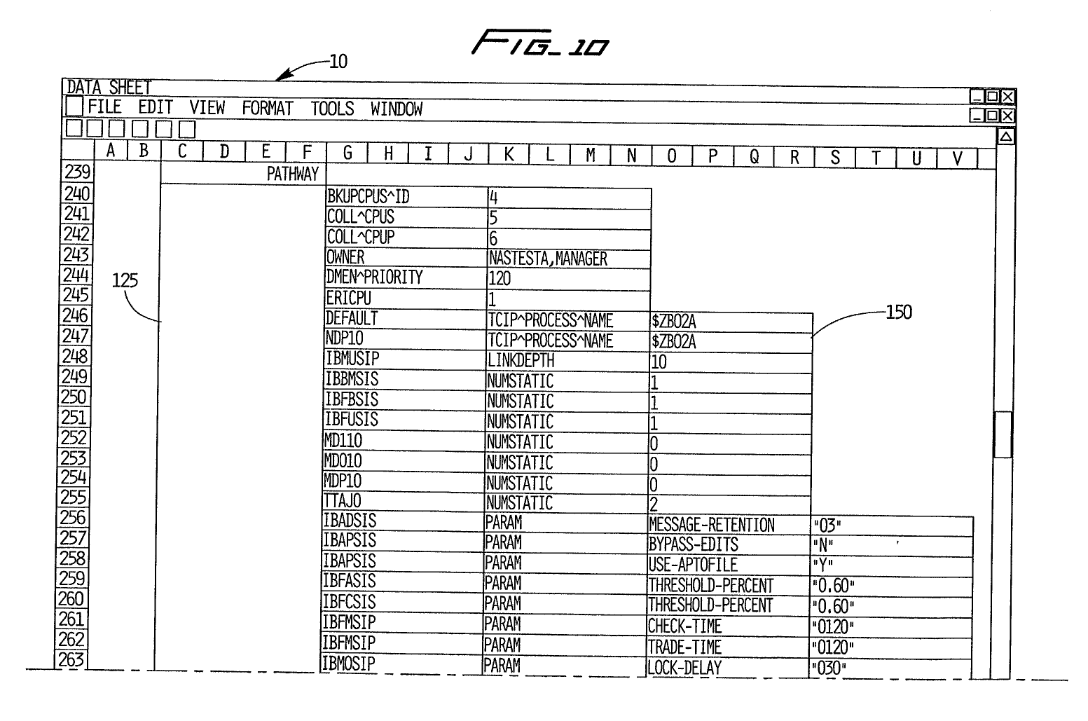

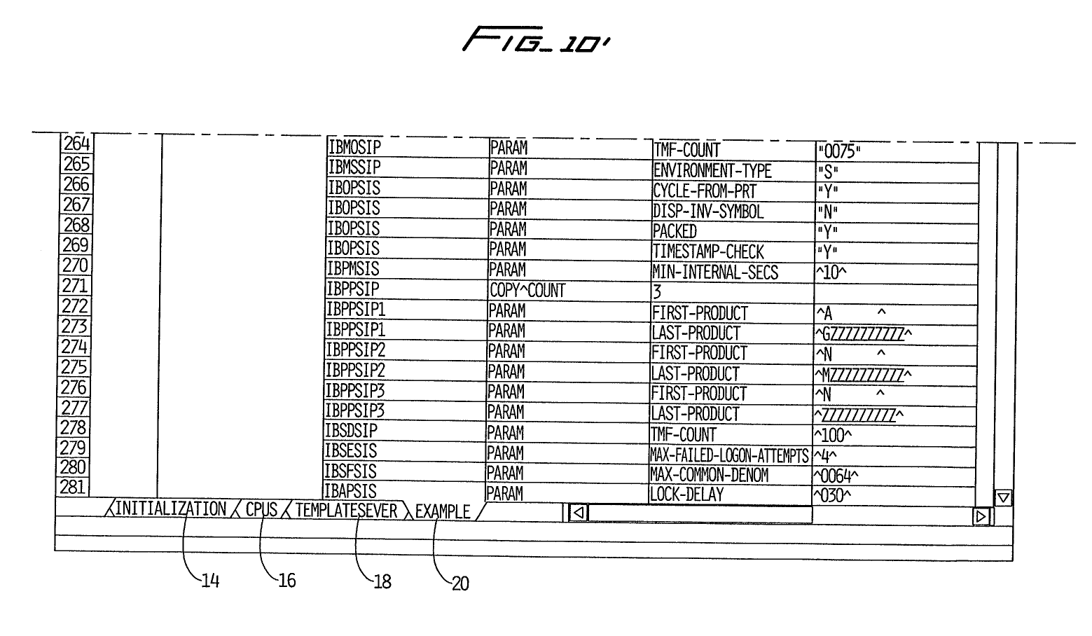

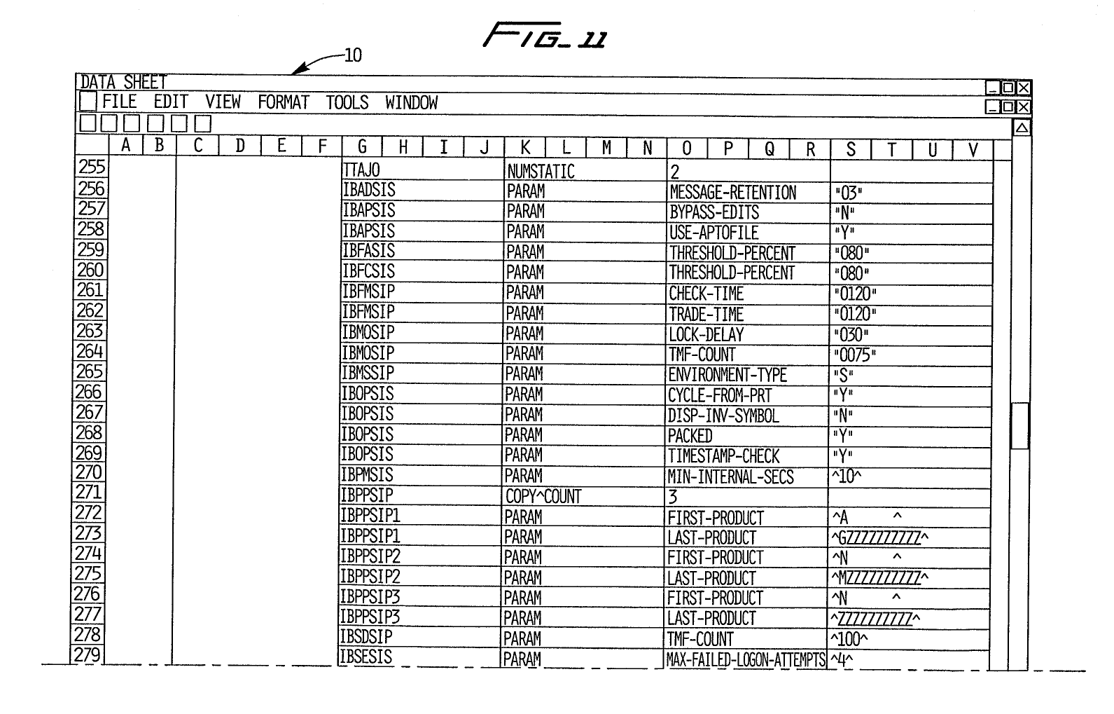

Referring to FIG. 2, the initialization data sheet 14 of workbook 10 contains initialization parameters for each environment. More particularly, initialization worksheet 14 includes a data location table 40 that contains process CPU assignments, file data volume assignments, root pathway parameters, and template server definitions for each identified environment in workbook 10. For example, the data location for the process CPU assignments for environment A is the data sheet named “Example” in the workbook 10. Furthermore, the data location for the file data volume assignments for environment A is the data sheet named “Environment” in workbook 10, as is the data location for the root pathway parameters for environment A.

FIG. 2 further illustrates table 50 which contains data used to transfer the environment configuration file to the host computer for each identified environment using File Transfer Protocols (FTP) for each identified environment in workbook 10. In particular, table 50 contains host designations, user designations, passwords and target file designations for each environment identified in workbook 10. For example, the host computer designation for environment A is 168.104.30.10 and the user is defined as rms.ppcd. The password for transferring the configuration script to the host computer is not shown but it may be text, a numeric string such as 140246, or a blank (null value) and the target file for receiving the configuration script on the host after it has been generated is designated as $data1. nascfg. envA. The password rule in the cell in table 50 must match the password rules of the host computer. It is envisioned and within the scope of the subject invention that the configuration script may be automatically transferred to the host computer, and then automatically executed on the host computer. In such an instance, the illustrated initialization tables would be modified appropriately.

FIG. 3 illustrates additional aspects of the Initialization worksheet 14 of workbook 10 including table 60 which contains local file names and directories for the configuration file that will be generated for each identified environment. It is envisioned that the environment configuration file can be network files, and can be viewed as an ASCII text file. Also, any existing files will be renamed to backup files before generation of the configuration proceeds. As set forth in table 60, the directory for the environment configuration file generated for environment A is designated C:\ApplicationSupport\ and the file name for the script file for environment A is Example.env.

FIG. 3 also illustrates program locations table 70 which includes directory paths and file names for applications used to view and transfer the script files generated for each identified environment in workbook 10. It is envisioned that these files can be local or network files. As set forth in table 70, the directory path for the script viewer used for environment A is C:\WINNT\ and the file name is NotePad. exe. The directory path for the file transfer program is defined as C:\Windows\ and the file name is Ftp.exe.

FIG. 4 illustrates table 80 of the Initialization worksheet 14 which contains data indicating the number of CPU's on which each identified environment will be configured. Valid values for this worksheet are indicated in table 90 as either 8 or 16. In general, a valid number in this table must be an even number. As set forth in table 80, environment A is to be configured across 8 CPU's. Thus, Environment A can be configured on a system which has 8 or more CPU's. It is envisioned and well within the scope of the subject disclosure that the Initialization worksheet could also include a table that identifies the first CPU in a group of CPU's assigned to a particular environment.

FIG. 5 illustrates the CPU's worksheet 16 of workbook 10, which includes table 100 that contains information used to determine the assignments for backup processes given the CPU used for the primary process. Referring to table 100, the columns headed 0 through 15 are the primary CPU assignments. Each row represents the number of CPU's in the environment being configured. As provided, only 8 and 16 CPU configurations are defined. The body of the table specifies the backup CPU number to assign to each primary CPU. Given this data, a server which has its primary process running on CPU 5 of an 8 CPU system will have its backup process running in CPU 2, while on a 16 CPU system the backup is assigned to CPU 13.

FIG. 6 illustrates the Template Server datasheet 18 of workbook 10, which includes table 105 containing a list of all Server Class names and indications as to whether the identified server is a TemplateServer Class or a normal Pathway Server Class. In accordance with the subject invention, the permitted values for this worksheet are True, False and empty. If the template field is filled with a True value, the server will be treated as a TemplateServer. If the template field is filled with a False value or is left empty, the server will be treated as normal Pathway Server Class. A drop down list is used to enter data in this range. As set forth in table 105, for example, the server class named IBPPSIP is a Template Server, while the server class named IBARSIS is a normal Pathway Server Class.

FIG. 7 illustrates table 110 of the environment data sheet 20, which contains the server process instances to be run in each CPU for the specific environment. The columns headed 0 through 15 are the CPU's where the process instances are running. The rows contain the environment specific server class names. Table 110 is populated with the server process instance to be run in each CPU. It is envisioned that for server classes that require more than 16 processes, the server class name cell is left blank to indicate that the row is to be treated as a continuation row. As illustrated, table 110 contains the server process instances for an environment configured on an 8 CPU system, and it includes columns for data entry for server classes that require Max Links and Processor Priority. Referring to table 110, by way of example, the server class IBAPSIS has a process instance running in CPU 5, while the server class IBCUSIP has three instances running in CPU's 0, 6 and 7. Furthermore, the server class IBMOSIP has 6 Max Links and a Process Priority of 153.

FIG. 8 illustrates table 120 of the environment data sheet 20, which contains the file names that will be located on the disk volume specified in the column header for the specific environment. Table 120 has a column for each data volume on the system. The file names are entered in the body of the table in the appropriate volume column. As set forth in table 120, by way of example, the file named FIFILE0 resides on the disk volume $DATA4, while the file named PI FILE resides on the disk volume $DATA8. A file name with under score _P suffix indicates the existence of a file partition. Thus, the specified file will be located on more than one disk volume. For example, the file named FBFILE has 4 partitions, 0 through 3, and they reside on disk volumes $DATA1, $DATA5,$DATA9 and $DATA13.

Referring to FIGS. 8A-8C, there are illustrated alternate version of a group of environment specific data sheets for an environment identified as J, on worksheet tab 20a of workbook 10a. FIG. 8A illustrates a table 420 which contains the definitions and disc volume placements for a set of data files. The first column of table 420 identifies each of the file names and the second column identifies the number of instances for each data file beginning with a single instance, including cluster files. Partitioned files are not included in Table 420, but in this case are identified in Table 430 which is illustrated in FIG. 8B. The next four columns in table 420 correspond to the four data disc volume names, $DATA22-$DATA25 and the entries set forth therein correspond to the file instances. Table 420 further includes several columns for defining attributes related to certain data files. In doing so, customized files can be designed which have attribute values that differ from the default values associated with a particular file. The attribute columns include a column to enter abstract files names, a column to identify a particular owner who can read or write to a particular data file, a column to identify the type of security associated with a particular data file, a column to enter the size units for a particular data file, and columns to enter the primary, secondary and maximum extent sizes for a particular data file. The size units and extent sizes can be represented by a number of pages of disk space, e.g., 500 pages, where a single page corresponds to 2K bytes of disk space. Additional columns are provided in the table for other attributes.

As noted FIG. 8B illustrates Table 430 which includes environment specific information relating to partitioned files not found in Table 420, i.e., those files which have been divided up among plural disc volumes to improve parallel processing across the system. Partitioned files are to be contrasted from cluster files which are treated as separate files that are logically designated by different names. Table 430 includes several columns containing information corresponding to a list of data files. The first column contains values relating to the number of partitions associated with a particular data file. The second column includes entries identifying the “First Key” so that the system can identify the initial boundary of a particular file. The last two columns contain values which indicate the primary and secondary extents of a particular data file. When the primary reserve is exhausted, the file acquires the secondary extent. These values correspond to the number of pages of disc space to be reserved.

FIG. 8C illustrates Table 440 which includes information relating to AltKey file names for a given set of indexed data files. Since indexed files names are generally stored as two or more files, they must be linked to each other. The entries in Table 440 ensure that the indexes for each data file are referenced from the base file.

FIG. 9 illustrates the Root Pathway work sheet 125 of the environment data sheet 20, which contains the generic and sub-system specific parameters required for each environment, namely <Common>, Netbatch, Ems, Pathway and Tmax. The columns on each table reflect the Tandem Advanced Computing Language (TACL) segment and directory structure for each variable. The entries in each table are the Variable Names and their Values. In each row, there are n column entries, where cells 1 to n-1 form the parameter name, and cell n provides the value of the parameter. The <Common>parameters of table 130 have no prefix and are generic Pathway parameters. The Netbatch parameters of table 140 are specific to the Netbatch shell. Ems table is not shown but it would define Event Management System parameters. The Pathway parameters of table 150 are individual server specific parameter and the Tmax parameters of table 160 are also specific to the Tmax sub-system.

As discussed hereinabove, the Microsoft Excel workbook 10 contains user specified contextual data and default data for configuring a Pathway application environment on a Compaq NonStop Server. The Software Configuration Manager (SCM) system of the subject invention also includes an environment-dependant script containing tokenized command lines defining initialization parameters for a specific environment. This tokenized file is located on the workstation along with the workbook containing the configuration data for the specific environment. A base configuration file containing default values for a Pathway application environment is located on the host computer in a repository.

The default values may be overridden by environment specific data located in the workbook, when the environment configuration file is created.

The workstation utilized to build and download an environment configuration file may be a personal computer running a Microsoft Windows NT application. The code generator which is program preferably in the form of a Microsoft Excel Addin file (e.g., Opsconfigcode.xla) which may be written in Microsoft Visual Basic, is employed to generate the Pathway application environment configuration script by replacing the tokens in the command lines with the user-specified contextual data contained in the workbook and the default data contained in the repository. An example of an environment-dependant tokenized script file for configuring a Pathway application environment is provided in Appendix A hereto and is incorporated herein by reference in its entirety.

The following text provides an example of a tokenized command line from an environment-dependant skeleton, such as the tokenized file provided in Appendix A, which relates to primary and secondary (backup) processor assignments for the server class named IBCUSIP:

?section :opsˆ env:pathway:IBCUSIP:CPUS text [:opsˆ env:cpu:std:pair1],[:opsˆ env:cpu:std:pair2],[:opsˆ env:cpu:std:pair3]

In this example the server class IBCUSIP has three process instances running. As shown in FIG. 7, table 110 indicates that the server class IBCUSIP has its three processes running in CPU's 6, 7 and 0.

In accordance with table 100 of FIG. 5, on an 8 CPU system, a server class running on primary CPU's 6, 7 and 0, will be assigned to backup CPU's 1, 0 and 4, respectively. In contrast, on a 16 CPU system such a server class will be assigned to backup CPU's 14, 15 and 8, respectively. Using the above example, the code generator will create the following command line for the process IBCUSIP in the opsˆ env:pathway directory on an 8 CPU system, where each CPU pair is separated by a comma:

?section :opsˆ env:pathway:IBCUSIP:CPUS text 6:1, 7:0, 0:4

The following text provides an example of a tokenized command line from an environmentdependant skeleton, such as the tokenized file provided in Appendix A, which relates to the target location or disc volume and sub-volume where the file PDXFILE will be installed:

?section :opsˆ env:files:PDXFILE text [:opsˆ env:optˆ dataˆ subvol].PDXFILE

Using information from table 120 of FIG. 8, the code generator will create the following command line for the file named PDXFILE in the specified environment, where the disc volume and sub-volume are $DATA8 and NAXDATAA, respectively:

:opsˆ env:files:PDXFILE $DATA8.NAXDATAA.PDXFILE

As described above with respect to FIGS. 9-11, there are five parameter subcategories that are common to all subsystems in a Pathway application, namely the <Common>generic parameter, Netbatch, Ems, Pathway, and Tmax. Each parameter has a name that is made up of one or more component strings, and each has an associated parameter value specified in the last column of the table.

In the Pathway configuration system of the subject invention, command lines are generated based upon the information contained in the Common Table.

An example of a command line from an environment-dependant skeleton, such as the tokenized file provided in Appendix A, for the generic Pathway parameter called “releaseˆ security” will read as follows, where the character string “NANA” is obtained from the <Common>table 130 of FIG. 9:

?section :opsˆ env:releaseˆ security text NANA

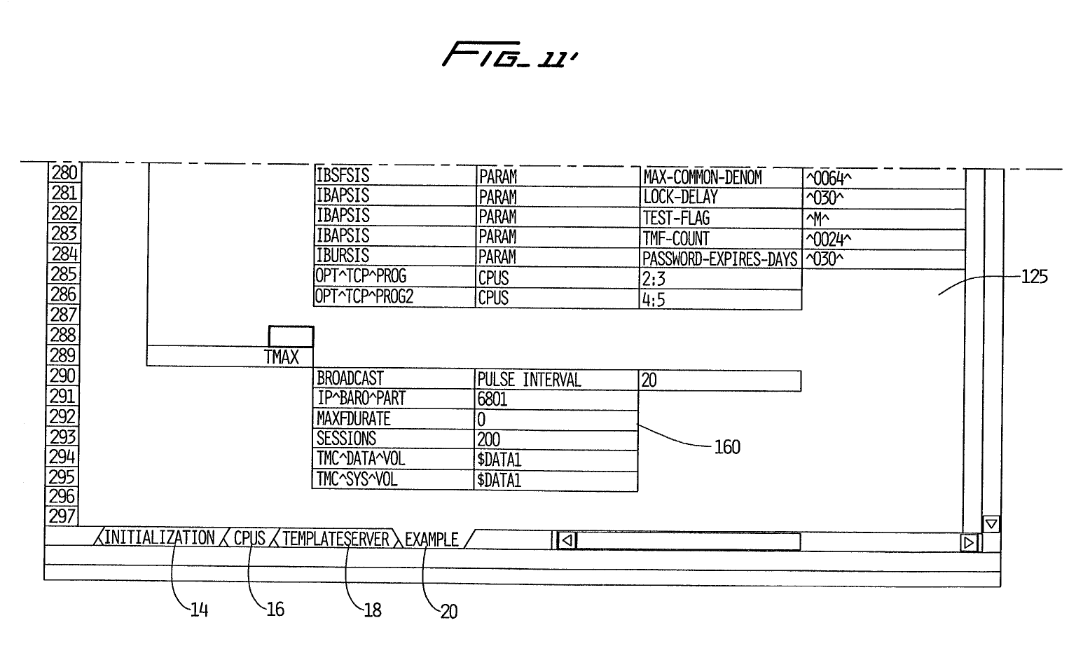

With reference to the Pathway table 150 of FIGS. 10-11, an example of a command line from an environment-dependant skeleton, such as the tokenized file provided in Appendix A, for the parameter value called “thresholdˆ percent” utilized in the pathway directory for the server class IBFBSIS will read as follows:

?section :opsˆ env:pathway:IBFBSIS:PARAM:thresholdˆ percent text

In another example, referring to table 160 of FIG. 11, the tokenized command line for the Tmax subsystem specific parameter with the parameter name “Broadcast PulseInterval” may read as follows:

?section :opsˆ env:tmax:Broadcast:PulseInterval text 20

In yet another example, the tokenized command line for the parameter value “TMFˆ COUNT” utilized in the netbatch directory for the server class IBFCSIP will read as follows:

?section :opsˆ env:netbatch:IBFBSIS:TMFˆ COUNT text 50

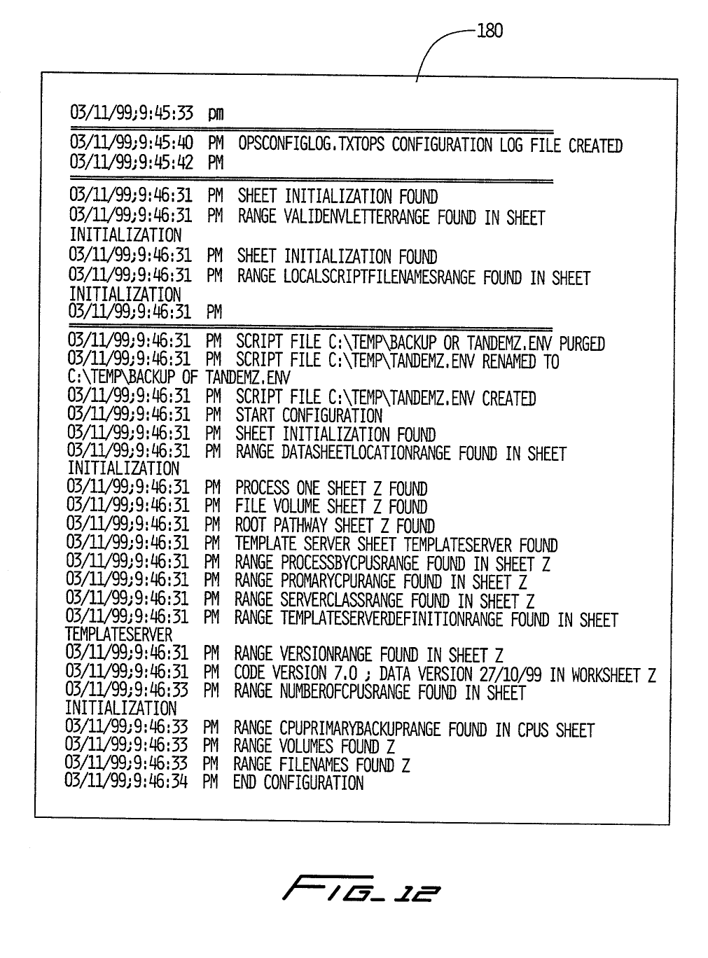

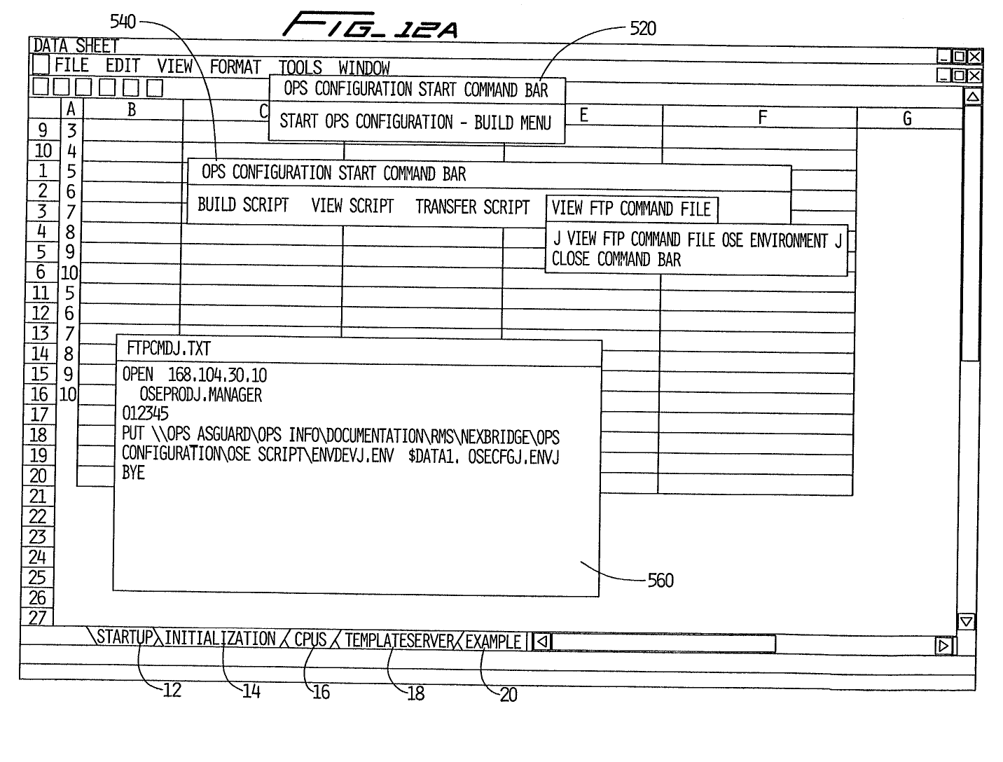

Referring to FIG. 12A, there is illustrated the command bars associated with workbook 10 for activating the application environment configuration process of the subject invention. In particular, FIG. 11A illustrates the Configuration Start Command bar 520 from which the user may access the Build Menu Command bar 540. From Command bar 540, the user may chose to: i) Build the configuration script from the tokenized file and the contextual data; ii) View the configuration script after it has been built; iii) Transfer the configuration script to the host computer after it has been built; or iv) View the FTP command file utilized to transfer the configuration script to the host computer. By way of example, FIG. 12A shows a Notepad 560 displaying the FTP Command File for Environment J.

Referring now to FIG. 12, there is illustrated a sample configuration log file 180 constructed in accordance with a preferred embodiment of the subject invention. As illustrated, the log file catalogues and tracks, by date and time, each sequential step in the configuration script generation process of the subject invention, beginning with the creation of the configuration log. Thereafter, the Initialization sheet 14 is found, and the valid environment letter range and the local script file name range are obtained therefrom. Then, the backup script file e.g., C:\temp\Backup is purged and renamed, whereupon the new script file e.g., C:\temp\TandemZ.env is created. At such time, the configuration is started. Thereupon, the Initialization sheet 14 is found again, and the data sheet location range is obtained from table 40. Next, in sequential order, the Process Cpu sheet 110, the File Volume sheet 120, and the Root Pathway sheet 125 (i.e., the Common, Netbatch, Pathway, Ems and Tmax parameters) are found for the specified environment, e.g., the TandemZ environment.

Then, the template server definition range is obtained from table 105 of the Template Server sheet 18, and the version range is found in the environment specific worksheet 20. In this example, for the specified environment, the Code Version (i.e., the tokenized file or skeleton) is 7.0 and Data Version (i.e., the user specified worksheet data) is 27/10/99. After the version range is found and specified in the log file, the number of CPUs range is obtained from table 80 of Initialization sheet 14. Next, the CPU primary backup range is found in table 100 of the CPU sheet 16 of the workbook 10. The volume range and file name range are then obtained from the environment specific data sheet 20. Thereafter, the configuration script generation process ends. After the configuration script is built, the output file named in the Initialization sheet (e.g., Example.env), it can be viewed using the script viewer specified in the Initialization sheet (e.g., NotePad.exe). In the event that there are inconsistent results, the log file should also be reviewed. Upon completing the review of the configuration script, the data workbook must be saved.

Referring now to the data sheets in FIGS. 2 and 3, after the configuration script has been generated and reviewed, it is transferred from the script file directory C:ApplicationSupport to the target file $data1.nascfg.envA on the host computer using the file transfer protocols found in directory C:\Windows\. Thereafter, the data workbook is closed and the user logs onto the host computer to configure the application environment that has been previously transferred thereto.

The SCM system of the subject invention also has a Revision Management System (RMS) repository associated therewith that contains source code which aids in tracking program versions, compiling programs and distributing and installing releases. More particularly, the RMS repository is populated with the scripts and skeletons that are required to configure an application environment on the host computer. Upon receipt of the configuration script file by the host computer, a shell executes using Compaq's scripting language known as Tandem Advanced Command Language (TACL). The shell converts the information in the configuration script file into a format that programs can read and execute. Furthermore, the shell withdraws information from the RMS repository as required to build a Pathway application environment. Once a Pathway application environment is configured on the host computer, the RMS repository populates that environment with the programs that make up a Pathway application. This is accomplished by interacting with Compaq's Enscribe suite of programs, which is a database management system that provides structure to files.

There are four primary TACL routines held in the repository, for installing and configuring a Pathway application environment on a host Compaq NonStop server using a configuration script generated by the SCM system of the subject invention. These TACL scripts include the CONFIG ROUTINE, the SETUP ROUTINE, the DBCREATE ROUTINE and the DBVERIFY ROUTINE.

The CONFIG ROUTINE, which is attached hereto as Appendix B and incorporated herein by reference in its entirety, configures an operational environment, and includes subroutines for, among other things, testing and validating environment parameters based upon established rules, and running macros for configuring certain subsystems, such as, the TMAX subsystem.

The SETUP ROUTINE, which is attached hereto as Appendix C and which is also incorporated herein by reference in its entirety, performs all necessary file management tasks to install and configure an application environment. In particular, the SETUP ROUTINE performs the following functions: 1) Validates environment configuration files to ensure that the file for the environment being installed is compatible with the release, has all required parameters, that all parameters have the correct content, and that any optional parameters are correctly specified; 2) Installs files in the operating environment using appropriate commands; 3) Modifies any alternate keys of files that have been copied; 4) Runs any file conversion programs required to upgrade or fallback the environment from the release currently installed to the release being installed; 5) Creates the release identification file in the target location and in the operating environment using the name of the release being installed; and 6) Runs the CONFIG ROUTINE to configure the shells containing the commands needed to bring up a subsystem, as well to create any data files required by the environment, which, during the first installation, includes creating all data files. The DBCREATE ROUTINE and the DBVERIFY ROUTINE function to create files and verify them by comparing attributes from one release to another. These routines are attached hereto as Appendixes D and E, respectively, and are incorporated by reference in their entireties.

Those skilled in the art will readily appreciate that an application can have multiple operating environments, and that there may be many available applications for a given computer platform. In addition, a business may have many different platforms in use at the same time. Therefore, in accordance with a preferred embodiment of the subject invention, it is envisioned that the application environment configuration system disclosed herein can be extended to create a generic, multi-platform configuration management system. The system is intended to support most major platform operating systems including Compaq NSK, UNIX, Linux, and Windows NT. The components of the system are preferably written in a generic language such as JAVA or ANSI C.

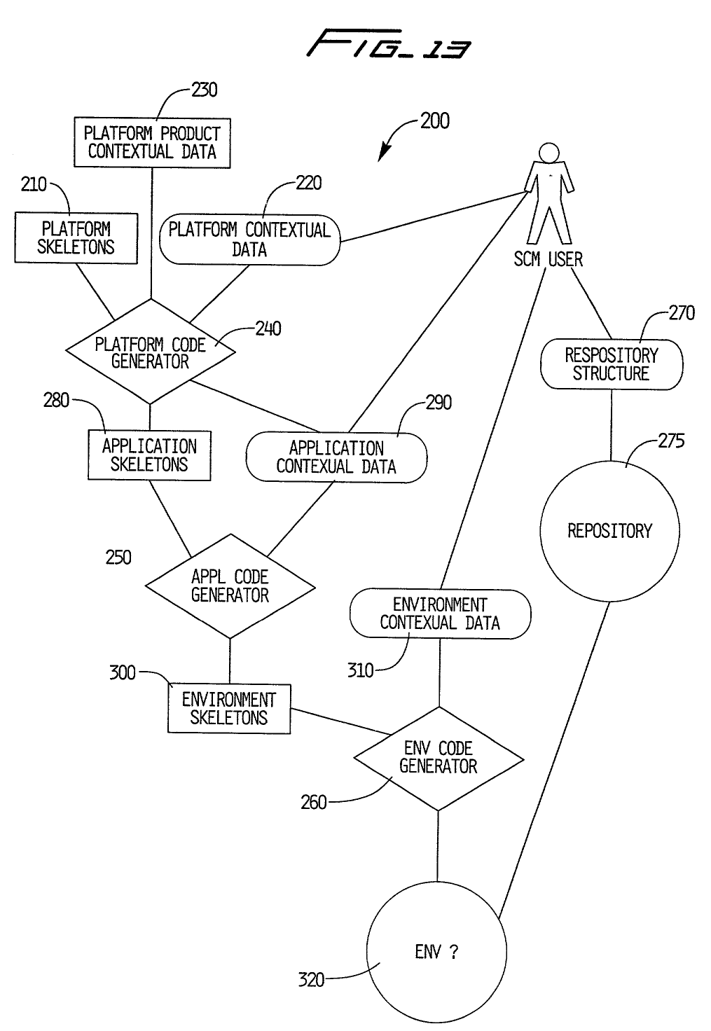

Referring to FIG. 13, the multi-platform configuration management system of the subject invention is designated generally by reference numeral 200 and includes platform related components, application related components and environment related components. The platform related components include: platform-dependent skeleton scripts or files 210, default platform-dependent contextual data 220, platform-dependant product contextual data 230, and a platform code generator 240. The system further includes an application code generator 250, an environment code generator 260, and structure 270 for a repository 275. These components are preferably in the form of a product contained on a computer readable storage medium used in conjunction with a configuration management workstation.

The platform-dependant skeletons 210 are files that contain a set of tokenized rules or conventions, which are parsed and combined with the platform-dependant contextual data 220, 230 to produce or compose application-dependent skeletons 280. These files may be written in TACL, Java, Perl, ANSI C or a similar command language, and may contain tokenized rules relating to, among other things, platform conventions such as file names, process names, spool/print facilities, database management, repository management, and std input/output queues. In cases where a particular platform has unique characteristics that are not shared with any other platform, a unique functionality would be built into the platform contextual data file.

The default platform contextual data 220 is a file that includes information such as licensing keys, communication settings and hardware drivers describing a platform convention. In the case of RMS, the files DDSLKEYS that permits the use of RMS on a client machine may represent such data, and in the case of Windows, the installation (.ini) and driver files may represent this type of data. A user may modify the default values to configure the platform to conform to specific corporate policies.

The product contextual data 230 consists of the products that make up a particular application.

In the case of a Compaq NonStop Server system, these products include Pathway, TACL, Java VM, OSS, iTP Web Server, and Enscribe. In the case of a Unix system, the products may include Oracle, Perl, Java VM and PVCS, and in the case of a Microsoft Windows NT Server the products may include MS SQL Server, Visual C++, DOS and Java VM. The platform code generator 240 is a tool such a macro that merges the tokenized platform-dependant skeletons with the platform-dependant contextual data to produce application-dependent skeletons 280. More particularly, it generates programs that provide the automation to install and configure applications and application environments on multiple platforms.

Application-dependant skeletons 280 are tokenized scripts or files that contain a set of rules for parsing and composing environment-dependant command lines. In the case of a Pathway application, these files may contain, among other things, tokenized rules relating to server names and disc volume designations such as those which are hard coded in the data sheets of FIGS. 7 and 8. Application-dependent contextual data 290 describes the configuration of an application. In the case of a Pathway application, the configuration data would include, among other things, the Pathway specific server names and Pathway specific subsystem data defined by a particular user. Preferably, the user provides this information by populating a generated spreadsheet. The application code generator 250 is preferably in the form of a macro programmed to merge the application-dependant contextual configuration data 290 with the application dependant skeletons 280 to create environment-dependant skeletons 300 with command lines relating to an application environment.

Environment-dependent skeletons 300 are configuration files that contain a stream of tokenized command lines relating to an environment. In a Pathway application environment, the tokenized command lines may be presented in a manner, such as, in the tokenized environment configuration script attached hereto as Appendix A. The environment-dependant contextual data 310 describes a particular environment, and in a Pathway application environment may include, among other things, the process instances for the server class names and the file name locations on the disc volumes. The user would specify this data by filling out generated spreadsheets. The environment code generator 260 is a macro that is preferably programmed to produce two sets of files to create an application environment, the configuration files and the scripts containing the protocols to transfer the files to the platform to build the application environment 320.

The multi-platform software configuration management system of the subject invention 200 is used to create the repository catalogue structure 270 which resides on the host computer and is used to manage the user's application and populate the repository 270. On the Compaq NonStop server platform the repository is RMS, while on Unix and Windows it could be PVCS or many other packages. The repository 275 must be populated by repository structure 270 with the application programs before an application environment is built.

In operation, the user initially modifies or overrides the default platform contextual data to suit a particular platform. Thereafter, the first building stage is executed, whereby application-dependant skeletons and default application contextual data are generated by the platform code generator 240. At such a time, the user can modify or overrides the default application contextual data to suit a particular application. Then, the second building stage is executed, whereby the environment-dependant skeletons and default environment contextual data are generated by the application code generator 250. Thereupon, the third building stage is executed, whereby all of the necessary components to build the environment are generated by the environment code generator 260, including the configuration files, and the scripts to FTP the files to the platform to build the environment 320. Thereafter, the scripts and configuration are downloaded to the platform, whereupon they are used by the scripts in the repository to build the environment. Once built, the application environment will include, among other things, empty data files, security definitions, directories and communications configurations. After the application environment 320 is constructed, an application consisting of a group of programs residing in the repository 275 can be installed thereon.

The above-described embodiments are merely illustrative of the principles of the present invention. Other embodiments of system and method of the present invention will be apparent to those skilled in the art without departing from the spirit and scope of the present invention, as defined by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for configuring an environment on a computer platform to facilitate installation of an application, the method comprising the steps of:
a) providing environment-dependant command lines containing a plurality of tokens;
b) providing environment-dependant contextual data describing an environment;
c) generating the environment by replacing the tokens in the environment-dependant command lines with environment-dependant contextual data.

2. A method according to claim 1, further comprising the steps of:
a) providing application-dependant rules for parsing and composing environmentdependant command lines, the application-dependant rules containing a plurality of tokens;
b) providing application-dependant contextual data describing an application configuration; and
c) generating the application configuration by replacing the tokens in the application-dependant rules with application-dependant contextual data.

3. A method according to claim 2, further comprising the steps of:
a) providing platform-dependant rules for parsing and composing application-dependant command lines, the platform-dependant rules containing a plurality of tokens;
b) providing platform-dependant contextual data describing a platform convention; and
c) generating the platform convention by replacing the tokens in the platform-dependant rules with platform-dependant contextual data.

4. A method according to claim 3, further comprising the steps of:
a) transferring the platform convention to the computer platform;
b) transferring the application configuration to the computer platform for installation based upon the platform convention; and
c) transferring the environment to the computer platform for configuration based upon the application configuration.

5. A method according to claim 1, wherein the step of providing environment-dependant contextual data comprises providing user specified contextual data describing the environment.

6. A method according to claim 2, wherein the step of providing application-dependant contextual data comprises providing user-specified contextual data describing the application configuration.

7. A method according to claim 3, wherein the step of providing platform-dependant contextual data comprises providing user-specified data describing the platform convention.

8. A method according to claim 1, wherein the step of providing environment-dependant contextual data comprises providing default data describing the environment.

9. A method according to claim 2, wherein the step of providing application-dependant contextual data comprises providing default data describing the application configuration.

10. A method according to claim 3, wherein the step of providing platform-dependant contextual data comprises providing default data describing the platform convention.

11. A method for configuring an environment on a host computer to facilitate installation of an application thereon, the method comprising the steps of:
a) providing a file containing a plurality of tokenized command lines for configuring an application environment;
b) providing contextual data describing the application environment;
c) generating a configuration script file by merging the contextual data with the tokenized command lines;
d) transferring the configuration script file to the host computer; and
e) configuring the application environment on the host computer based upon the configuration script file.

12. A method according to claim 11, wherein the configuration script file is transferred to the host computer using file transfer protocals.

13. A method according to claim 11, further comprisng the step of populating the application ; environment.

14. A method according to claim 11, wherein the step of providing contextual data describing the application environment includes providing contextual data relating to process instances for server classes.

15. A method according to claim 11, wherein the step of providing contextual data describing the application environment includes providing contextual data relating to disc volume locations for files.

16. A method according to claim 11, wherein the step of providing contextual data describing the application environment includes providing contextual data relating to backup assignments for CPUs.

17. A system for configuring an environment on a computer platform to facilitate installation of an application, the method comprising the steps of:
a) environment-dependant command lines containing a plurality of tokens;
b) environment-dependant contextual data describing an environment;
c) an environment code generator for generating the environment by replacing the tokens in the environment-dependant command lines with environment-dependant contextual data.

18. A system as recited in claim 14, further comprising:
a) application-dependant rules for parsing and composing environment-dependant command lines, the application-dependant rules containing a plurality of tokens;
b) application-dependant contextual data describing an application configuration; and
c) an application code generator for generating the application configuration by replacing the tokens in the application-dependant rules with application-dependant contextual data.

19. A system as recited in claim 18, further comprising:
a) platform-dependant rules for parsing and composing application-dependant command lines, the platform-dependant rules containing a plurality of tokens;
b) platform-dependant contextual data describing a platform convention; and
c) a platform code generator for generating the platform convention by replacing the tokens in the platform-dependant rules with platform-dependant contextual data.

20. A system as recited in claim 19, further comprising a repository structured to contain applications for installation within the environment.

21. A system for configuring an environment on a host computer to facilitate installation of an application thereon, the system comprising:
a) a file containing a plurality of tokenized command lines for configuring an application environment;
b) contextual data describing the application environment;
c) means for generating a configuration script file by merging the contextual data with the tokenized command lines;
d) means for transferring the configuration script file to the host computer; and
e) means for configuring the application environment on the host computer based upon the configuration script file.

22. A method according to claim 21, wherein the contextual data describing the application environment includes providing contextual data relating to process instances for server classes.

23. A method according to claim 21, wherein the contextual data describing the application environment includes providing contextual data relating to disc volume locations for files.

24. A method according to claim 21, wherein the step of providing contextual data describing the application environment includes providing contextual data relating to backup assignments for CPUs.

25. A system as recited in claim 21, wherein the means for transferring the configuration script file to the host computer includes file transfer protocols.

26. A system as recited in claim 21, wherein the means for configuring the application environment includes configuration routines written in a command language understood by the host computer.

27. A system as recited in claim 21, further comprising means for populating the application environment.

28. A system as recited in claim 21, further comprising means for testing environment configuration parameters based upon established rules.

29. A system as recited in claim 21, further comprising means for validating environment configuration files.

30. A system as recited in claim 21, further comprising means for installing environment configuration files in the environment using appropriate commands.

31. A system as recited in claim 21, further comprising means for modifying any alternate keys of environment configuration files that have been copied.

32. A system as recited in claim 21, further comprising means for running file conversion routines required for changing the environment from a release currently installed to a release being installed.

33. A system as recited in claim 21, further comprising means for creating the release identification file in a target location and in the environment using a name of the release being installed.

34. A computer-readable medium, the contents of which causes a computer system to configure an environment on a host computer to facilitate installation of an application thereon, by performing the following steps:
a) providing a script file containing a plurality of tokenized command lines for configuring an application environment;
b) providing a data file containing contextual configuration data describing the application environment; and
c) generating a configuration script file by merging the contextual configuration data from the data file with the tokenized command lines of the script file for subsequent transfer to the host computer to configure the application environment.

35. A computer-readable medium as recited in claim 34, wherein the data file is in the form of a workbook containing a plurality of spreadsheets each containing configuration data relating to an aspect of the application environment.

36. A computer-readable medium as recited in claim 33, wherein the configuration data includes data relating to process instances for server classes.

37. A computer-readable medium as recited in claim 33, wherein the configuration data includes data relating to disc volume locations for files.

38. A computer-readable medium as recited in claim 33, wherein the configuration data includes data relating backup assignments for CPUs.
